(19) United States
(12) Patent Application Publication
(10) Pub. No.: US 2020/0348757 A1
(43) Pub. Date: Nov. 5, 2020

(54) FORCE SENSORS FOR HAPTIC SURFACES

(71) Applicant: IMMERSION CORPORATION, San Jose, CA (US)

(72) Inventors: Simon Forest, Montreal (CA); Peyman Karimi Eskandary, Montreal (CA)

(73) Assignee: IMMERSION CORPORATION, San Jose, CA (US)

(21) Appl. No.: 16/403,351

(22) Filed: May 3, 2019

(51) Int. Cl. G06F 3/01; G06F 3/041; G06F 1/16

(52) U.S. Cl. CPC G06F 3/016; G06F 3/0416; G06F 2203/04104; G06F 2203/04105; G06F 1/1681

(57) ABSTRACT

Systems and methods for force sensors for haptic surfaces are disclosed. One disclosed system includes a support; a touch surface configured to detect contact with the touch surface and output one or more contact signals indicating a location of the contact; a pivot mechanism coupled to the touch surface and the support, the pivot mechanism enabling the touch surface to rotate about a pivot axis; a sensor positioned to detect a force associated with the contact and to transmit one or more sensor signals indicating the force; a non-transitory computer-readable medium; and a processor in communication with the sensor and the non-transitory computer-readable medium, the processor configured to execute processor-executable instructions stored in the non-transitory computer-readable medium to: receive the one or more sensor signals and the one or more contact signals; and a contact force exerted on the touch surface based on one or more of the contact signals and one or more of the sensor signals.

### FIELD

The present disclosure relates generally to force sensors. More specifically, but not by way of limitation, force sensors that provide pressure readings for haptic surfaces.

### BACKGROUND

Haptic-enabled devices and environments have become increasingly popular. Such devices and environments provide a more immersive user experience. Many modern user interface devices provide haptic feedback as the user interacts with the device.

Many user interface devices, however, may lack the capability of providing accurate and consistent pressure readings that correspond to user interactions. Such an inability to reliably determine pressure readings may diminish the overall user experience. Therefore, force sensors that do not jam, read pressure precisely, with repeatability and reliability are desirable.

### SUMMARY

Various embodiments of the present disclosure provide force sensors for haptic surfaces. One example system includes a support; a touch surface configured to detect contact with the touch surface and output one or more contact signals indicating a location of the contact; a pivot mechanism coupled to the touch surface and the support, the pivot mechanism enabling the touch surface to rotate about a pivot axis; a sensor positioned to detect a force associated with the contact and to transmit one or more signals indicating the force; a non-transitory computer-readable medium; and a processor in communication with the sensor and the non-transitory computer-readable medium, the processor configured to execute processor-executable instructions stored in the non-transitory computer-readable medium to: receive the one or more sensor signals and the one or more contact signals; and determine a contact force exerted on the touch surface based on one or more of the contact signals and one or more of the sensor signals.

One example method includes receiving, from a touch surface that is coupled to a pivot mechanism and enabled to rotate about a pivot axis by the pivot mechanism, one or more contact signals indicating a location of a contact with the touch surface; receiving, from a sensor that is positioned to detect a force associated with the contact, one or more sensor signals indicating the force applied to the touch surface during the contact; and determining a contact force exerted on the touch surface based on one or more of the contact signals and one or more of the sensor signals.

These illustrative examples are mentioned not to limit or define the scope of this disclosure, but rather to provide examples to aid understanding thereof. Illustrative examples are discussed in the Detailed Description, which provides further description. Advantages offered by various examples may be further understood by examining this specification.

### BRIEF DESCRIPTION OF THE DRAWINGS

The accompanying drawings, which are incorporated into and constitute a part of this specification, illustrate one or more certain examples and, together with the description of the examples, serve to explain the principles and implementations of the certain examples.

FIG. 1 shows an example force sensor for haptic surfaces.

FIGS. 2A-2C show examples of force sensors for haptic surfaces.

FIG. 3 shows an example force sensor for haptic surfaces.

FIGS. 4A and 4B show examples of pivot mechanisms for force sensors for haptic surfaces.

FIGS. 5A and 5B show examples of double-pivot mechanisms for force sensors for haptic surfaces.

FIGS. 6A-6C show examples of centered, double-pivot mechanisms for force sensors for haptic surfaces.

FIG. 7 shows an example force sensor communicatively coupled to a computing device.

FIGS. 8-11 show example systems employing force sensors for haptic surfaces.

FIG. 12 shows an example method for force sensing using example force sensors for haptic surfaces.

FIG. 13 shows an example computing device suitable for use with example force sensors for haptic surfaces.

### DETAILED DESCRIPTION

Examples are described herein in the context of force sensors for haptic surfaces. Those of ordinary skill in the art will realize that the following description is illustrative only and is not intended to be in any way limiting. Reference will now be made in detail to implementations of examples as illustrated in the accompanying drawings. The same reference indicators will be used throughout the drawings and the following description to refer to the same or like items.

In the interest of clarity, not all of the routine features of the examples described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another.

To enable more reliable and consistent force sensing on surfaces, including haptic surfaces, an example system according to the present disclosure includes a touch surface attached to and supported on one side by a pivot mechanism and on the opposite side by a pressure sensor. In this example, the pivot mechanism is connected along the length of one side of the surface, while the pressure sensor is positioned approximately midway along the opposite edge of the surface.

At rest, the surface may exert a constant pressure on the pressure sensor, which outputs a corresponding pressure reading to a processor. This constant rest (or baseline) pressure is treated as a DC offset (or displacement from zero) for the sensor signal, i.e., it is treated as zero pressure. When a user applies a force to any portion of the surface, it causes the surface to rotate about the pivot mechanism, thereby applying an increased force on the pressure sensor. However, because the surface is supported by both the pivot mechanism and the pressure sensor, the angle of rotation about the pivot mechanism is small enough that it can be approximated as a purely vertical displacement, which eliminates the need to correct for horizontal components of a pressure vector. However, because the user may touch the surface at any location, the force sensed by the pressure sensor may not reflect the actual force applied by the user. Instead, the pressure reported to the processor is processed based on the reported location of the contact to determine the amount of pressure applied by the user.

In this illustrative example, a force sensor configuration using one force sensor provides a simple structure by which to sense force across an entire surface, making the sensor less expensive, e.g., costs are reduced because only a single force sensor is employed, reducing an overall complexity of the sensor and device design, and reducing processing requirements to determine an applied force, while still capable of measuring applied forces consistently, irrespective of where on the surface that force was applied. Further, a force sensor configuration using one force sensor provides a simple structure by which to sense force across an entire surface, making the sensor easier to calibrate, e.g., costs are further reduced because calibration of only a single force sensor is required, while still capable of measuring applied forces consistently, irrespective of where on the surface that force was applied. In addition, a force sensor configuration that employs rigid materials sufficient to allow a simple structure to hold a surface in a flat plane enables easier sensor calibration as secondary effects, such as deflection or deformation of the surface, is less likely to have a significant effect on any sensed pressures. Further, such a force sensor configuration employing sufficiently rigid materials can help avoid jamming of the pivot mechanism associated with repetitive applications of force, thereby increasing the reliability of the device.

This illustrative example is given to introduce the reader to the general subject matter discussed herein. The disclosure is not limited to this example. The following sections describe various examples of force sensors for haptic surfaces.

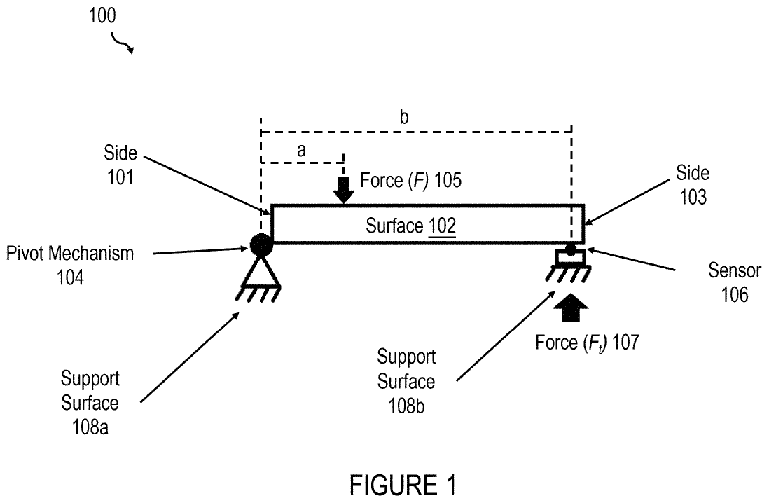

Referring now to FIG. 1, FIG. 1 shows a block diagram of one example force sensor system 100. In the example shown in FIG. 1, the force sensor system 100 includes a surface 102 that is coupled to a pivot mechanism 104 at one side 101 of the surface 102. The other side 103 of the surface 102 rests on a sensor 106. The pivot mechanism 104 and the sensor 106 provide a support structure for the surface 102 and because the surface 102 is resting on the sensor 106, it exerts a baseline force on the sensor 106. The surface 102 includes one or more sensors to detect contact with the surface and provide one or more signals indicative of the location of the contact.

While in the example shown in FIG. 1, the surface 102 is not haptically enabled, in other examples one or more actuators or other haptic output devices may be in communication with the surface 102 to apply haptic effects to it. Further, in some examples, the surface 102 may be a deformable surface that is able to deform in response to one or more input signals and output deformation haptic effects in response to such input signals.

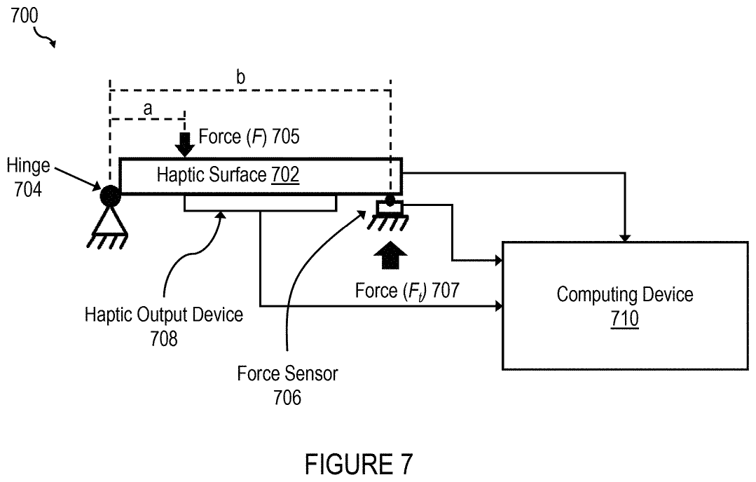

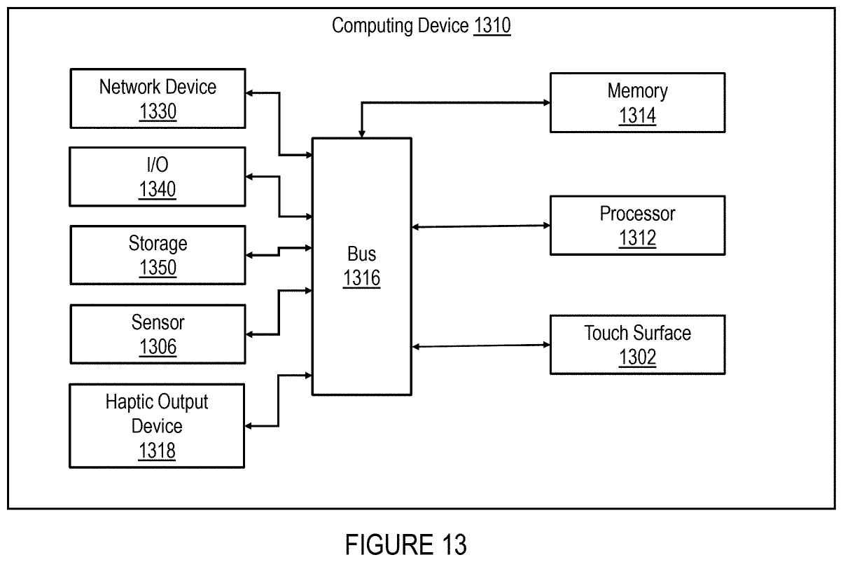

FIG. 1 also shows that the pivot mechanism 104 anchors the surface 102 by rigidly holding the pivot mechanism 104 in place against the sensor 106. The surface 102 and the sensor 106 are communicatively coupled to a computing device (not shown) to provide signals to the computing device. In this example, the surface 102 provides signals indicating a location of contacts with the surface 102, while the sensor 106 provides signals indicating a response of the surface to the contact, such as displacements, pressures, or forces detected by the sensor 106. The computing device may receive signals from both the surface 102 and the sensor 106 that indicate a user interaction. Using the signals, the computing device can determine the location of the user interaction. The computing device may also calculate the amount of force F 105 applied at that location or locations, as will be described in greater detail below with respect to FIGS. 7 and 13.

In this example, the surface 102 may be one of many different varieties of surfaces. For example, surface 102 may be a touch surface, touchpad, touch display, a surface in a vehicle (e.g., a dashboard, center console, steering wheel, infotainment system, etc.), a desk or chair, a table, a haptically-enabled touch surface, or any other suitable touch surface. In one example, surface 102 may be a touch-sensitive display screen. The surface 102 may report location data associated with a user interaction with the surface 102. The location data reported by the surface 102 may identify the presence or absence of a user interaction, the location of the user interaction, a change in location, path, velocity, acceleration, pressure, or other characteristic of a user interaction over time, or other location data associated with user interaction. Further, in some examples, the surface 102 is a multi-touch surface that reports location data associated with multiple contact locations to the computing device. However, in some examples, the surface 102 contains within (e.g., integrated within the structure of the surface) or is communicatively coupled to a non-contact location-sensing device, e.g., a Hall effect sensing device, a proximity sensor, or another non-contact sensing mechanism, to detect a location of an object proximate (e.g., a threshold distance) the surface. In some examples, the surface may detect an object proximate to the surface where the threshold distance is a predetermined distance such as 3 μm, 5 μm, 30 μm, or 5 mm, however, any suitable threshold distance may be employed according to different examples.

In some examples, the pivot mechanism 104 that is coupled to the surface 102 employs a pivot mechanism that is sufficiently rigid to apply a pre-compression force on the sensor 106. For example, the pivot mechanism 104 may be a movable, jointed or flexible device that may include one or more hinges, piano hinges, Sarrus mechanisms, linear bearing assemblies, leaf springs, flexural members, or any combination of these. The pivot mechanism 104 coupled to the surface 102 holds the surface in a plane so that it exerts a constant force on the force sensor, even in the absence of a user (or other) interaction, that can be treated as zero force or a constant error signal from the sensor 106, which can be filtered out when a user contact is detected.

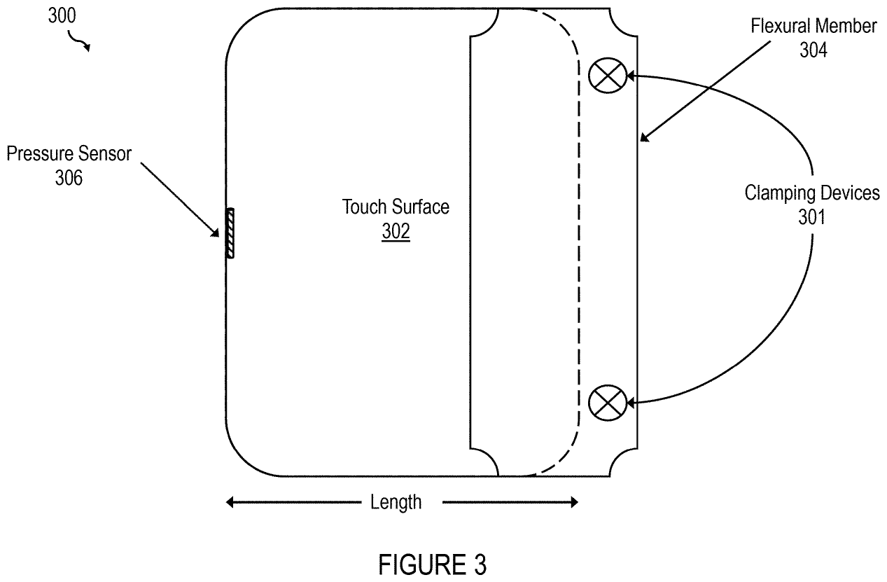

As mentioned above, the pivot mechanism 104 may include one or more flexural members, such as one or more flexural beams, flexural columns, tie rods, trusses, pieces of sheet metal (e.g., steel), a leaf spring, plastic, a suitable polymer, carbon fiber, a composite fiber, etc., that is affixed to a support surface 108a and cantilevers away from the support surface 108a. It may also be advantageous to employ a pivot mechanism 104 made with one or more rigid materials, e.g., a metal, alloy, a composite fiber, or carbon fiber, to ensure reduction or avoidance of unintentional motion of the surface 102. Examples of flexural members are discussed in greater detail with respect to FIG. 3.

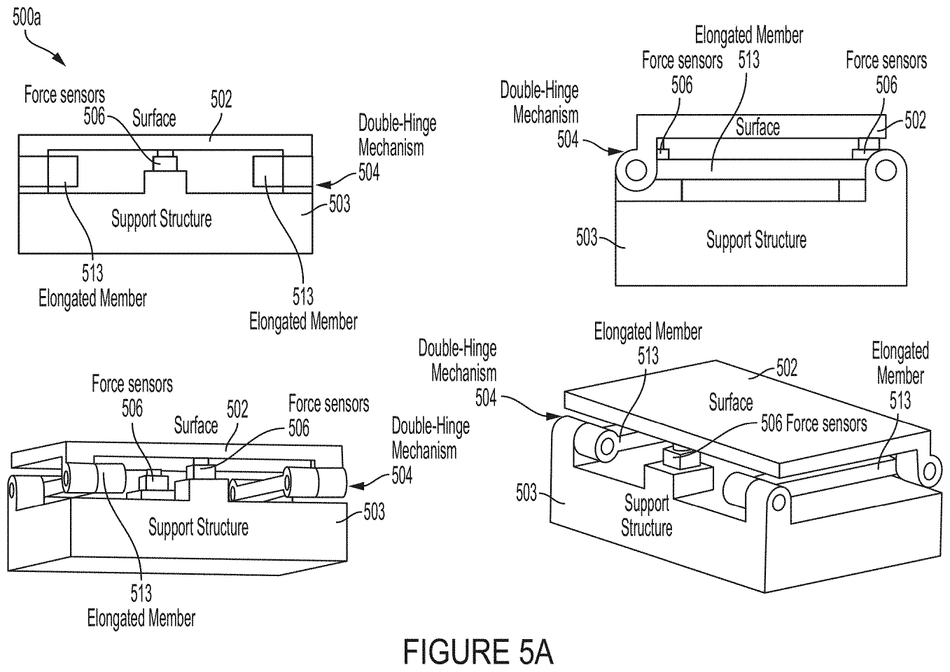

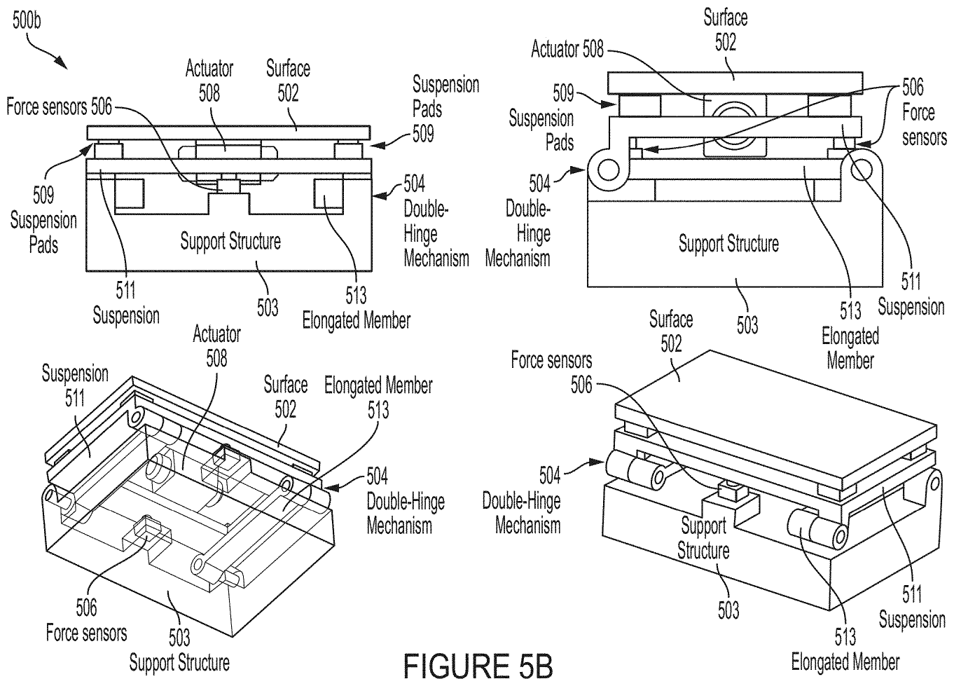

In operation, a user may at some time may contact the surface 102, thereby exerting a force F 105 on the surface 102 at the location of the contact. The exerted force is sensed by the sensor 106 and the sensor 106 outputs one or more sensor signals indicating the sensed force or pressure. However, the sensed force may differ from the applied force based on the location of the applied force. For example, a contact force applied very close to the pivot mechanism may be sensed as a substantially smaller force than was actually applied due to the differences in lever arms applied by the contact (near the pivot mechanism) and the force sensor (distant from the pivot mechanism). In this example, a larger lever arm, or perpendicular distance to the axis of rotation, results in a greater amount of torque being applied to the surface based on the rotation about the axis. In some examples, the pivot mechanism may have one or more pivot points that enable a lever arm to rotate about an axis of rotation (e.g., pivot axis). Such pivot points may correspond to attachment points where the pivot mechanism is coupled to the surface, or to another member, e.g., as shown in FIG. 5A (described in detail below).

To correct for the likely discrepancy between the applied force F 105 and the sensed force, a computing device (not shown) receives the signals output by the sensor 106 indicating the sensed force, and the signals output by the surface 102 indicating the location of the contact on the surface 102. The computing device then computes the applied force based on both sets of information, as will be described in greater detail below with respect to FIGS. 7 and 13.

As discussed above, the pivot mechanism 104 is affixed to a support surface 108a, such as a PCB or housing of a computing device, though in some examples, the surface may be a part of a desk, a chair, a vehicle dashboard, steering wheel, vehicle console (e.g., HVAC controls or radio controls), a vehicle steering wheel, a tablet, a laptop, a mousepad, a touchpad, a dedicated touch-input device, or any other suitable surface. The pivot mechanism 104 may be affixed using any suitable coupling mechanism, such as by one or more clamps, screws, or another suitable device, or by an adhesive, e.g., a pressure-sensitive adhesive, an epoxy, an extension of the housing, etc. To provide more consistent rotation or application of force to the sensor 106, it may be advantageous to evenly space the coupling mechanisms or use a uniform application of an adhesive, thereby reducing or preventing rotation of the surface in additional degrees of freedom other than about the pivot mechanism's axis of rotation. Further, in some examples, the pivot mechanism 104 may be pre-stressed to apply a biasing force, e.g., using a spring or flexural member, on the surface 102 to establish the baseline force at the sensor 106. For example, a spring or flexural member may be coupled to the surface 102 and a support surface 108a,b to pull the surface 102 towards the support surface 108a,b. Such a biasing force may reduce unintentional movement of the surface 102, such as due to movement of a device including the surface 102, air movement over the surface 102, etc.

As discussed above, the sensor 106 senses a response of the surface 102 to a contact with the surface 102. Thus, in some examples, the sensor 106 may measure one or more forces F 105 applied to the surface 102 and output sensor signals indicative of those forces. Further, the surface 102 may also determine a location of an applied force by determining the location of the one or more parts of a user's hand in contact with the surface 102. For example, the surface 102 may be a touch-enabled surface, such as a touchpad, touch display, a haptically-enabled touch surface, or any other surface suitable capable of determining the location of a user or object in contact with or interacting with the surface. In some examples, a computing device may be communicatively coupled to an external sensor (not shown), e.g., an infrared (“IR”) sensor, a camera sensor, a proximity sensor, a motion detector, an imaging sensor, a light-emitting diode (“LED”) sensor, or any other suitable external location sensing device to detect a contact location on the surface 102. It may also be advantageous for the surface 102 to output haptic effects, such as based on the location or force of the user interaction with the surface or detected events, such as user interface selections, virtual button presses, virtual slider movement, scrolling through a virtual list of items, etc. It may also be advantageous for the surface to identify the presence or absence of a user interaction, the location, change in location, path, velocity, acceleration, pressure, or other characteristic of a user interaction over time. These advantages, as well as other advantages of haptification, will be described in greater detail below with respect to other figures.

In some examples, the sensor 106 may be a type of force sensor suitable to measure an applied force in at least one degree of freedom. For example, the sensor may be a force sensor, a piezo sensor (e.g., a piezoelectric sensor, a piezoresistive sensor, or a piezo-ceramic sensor), an s-beam load cell, a strain gauge, a pressure-sensitive device, a direct beam, a capacitive device, a flexural box, a force transducer, a force-sensitive or force-sensing resistor (“FSR”), a non-contact sensor, or any other suitable pressure measurement device. It may be advantageous for the sensor to allow minimal displacement. For example, the amount of displacement of the force sensor may be limited to 3 μm. By selecting a force sensor that allows little displacement, forces applied to the surface 102 can be accurately approximated as solely vertical movement.

It should also be appreciated that sensor 106 may detect characteristics indicative of an applied force, e.g., a response of the surface 102 to an applied force, rather than a pressure or force explicitly. For example, the sensor may be non-contact sensor that measures displacement or distance. Thus, as a result of a contact, the surface 102 may deflect towards the sensor 106, causing a change in the sensor's output, or triggering the sensor 106 to output one or more sensor signals. Changes in the distance between the sensor 106 and the surface 102 may be mapped to a sensed force based on modelled physical properties of the surface 102, such as a relationship between applied force, contact location (or lever arm), and a detected displacement or change in position. Such non-contact sensors may include a Hall effect sensing device, a proximity sensor, an angular sensor, rotary encoder, torque sensor, displacement sensor, or another non-contact sensing mechanism, to detect an amount of force applied to the surface 102.

As discussed above, the force sensing performed by sensor 106 is associated with a substantially vertical directional movement. In one example, the pivot mechanism 104 and surface 102 are at rest in a flat plane, or flat parallel planes, and that plane may be substantially perpendicular to the directional movement associated with the force sensing of the sensor 106. Such an arrangement allows the pivot mechanism 104, coupled to surface 102, to maintain the flatness of surface 102. In other words, at rest the pivot mechanism 104 and the surface 102 at the location corresponding to the sensor 106 are substantially co-planar. Thus, when a user applies a force F 105 to surface 102, the pivot mechanism 104 may deflect or rotate about an axis to allow the surface 102 to move in a substantially linear direction towards the sensor 106. Further, in some examples, the sensor 106 may include more than one sensor. For example, multiple force sensors may be evenly spaced along the edge of the surface opposite the pivot mechanism 104.

Referring again to FIG. 1, the force sensor system 100 is communicatively coupled to a computing device (not shown). The computing device may store program code for calculating the amount of force F 105 applied by a user at a location. A user may interact with the surface 102 by applying a force F 105 to the surface 102. When the user applies an amount of force F 105 to the surface, a different amount of force Fₜ 107 is read and output by the sensor 106. And the location of the user interaction may be output by the surface 102. The sensed location data and force data output by surface 102 and sensor 106, respectively, is sent to the computing device. This information may be used to determine the applied force F.

For example, the distance b shown in FIG. 1 is the distance between substantially the center point of pivot mechanism 104 and substantially the center point of sensor 106. The computing device may use the location data associated with the force F 105 to determine the distance a shown in FIG. 1, the distance a being the distance between the pivot mechanism 104 and the location of the user interaction. For example, the reported location may be an (x, y) coordinate indicating a location on the surface 102. The processor may employ a mapping from the (x, y) coordinate to a spatial location on the surface relative to the pivot mechanism 104 or the sensor 106. The pivot mechanism 104 coupled to surface 102 only rotates slightly due to the presence of the sensor 106 supporting the opposite side of the surface 102. Thus, the portion of the surface 102 that is in contact with the sensor 106 may be assumed to move only in a substantially vertical direction (or, more generally, in a single degree of freedom). Further, the rotational movement of the pivot mechanism 104 may be sufficiently small enough that any flexion of the pivot mechanism 104 may be assumed to be a function of the rotational element of the pivot mechanism 104. With these assumptions, and considering the distance b is a fixed length based on the distance from the center point of pivot mechanism 104 to the center point of sensor 106, the relative amount of force applied to the location a of the user interaction may be calculated based on the expressions below.

$$\sum {M}_{H i n g e} = - a F + b {F}_{t} = 0 \\ ∴ aF = b {F}_{t} \\ ∴ F = \frac{b}{a} {F}_{t}$$

Thus, based on the sensed force and the location of the contact, the applied force may be determined.

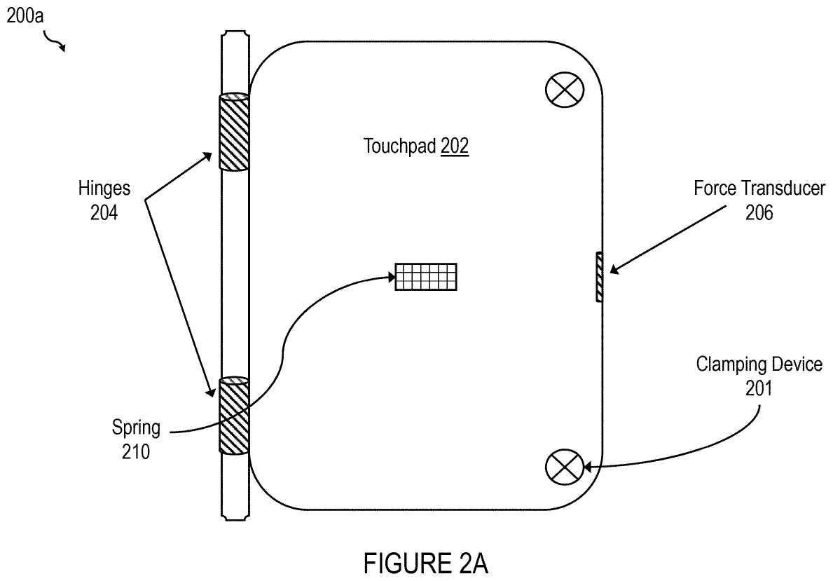

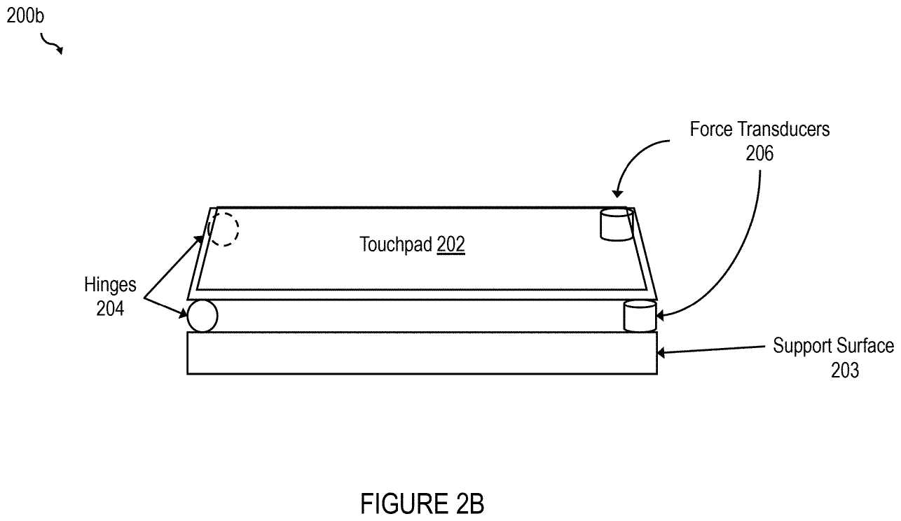

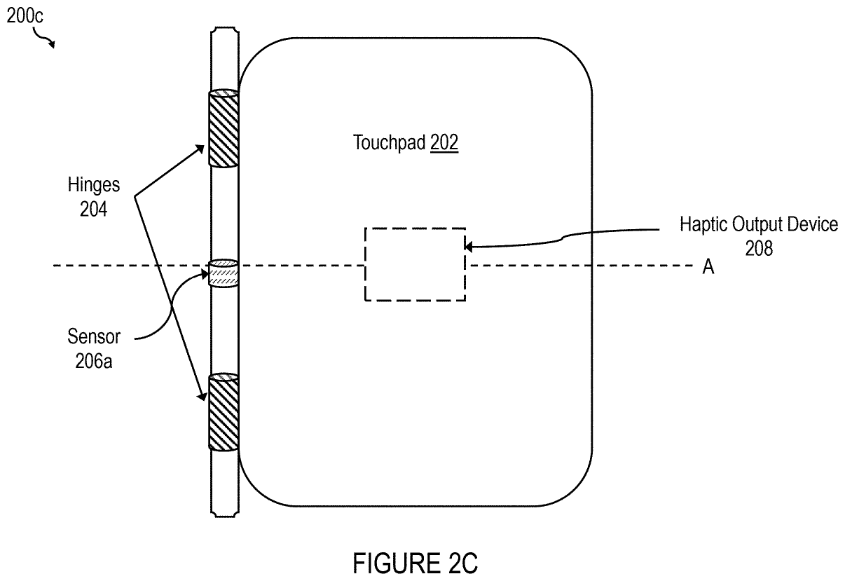

Referring now to FIG. 2A, FIG. 2A shows an example of an overhead view of a force sensor system 200a for haptic surfaces. The force sensor system 200a includes touchpad 202, which is coupled to two hinges 204 that rotate about pins inserted through the respective hinges 204. A force transducer 206 is positioned substantially equidistant between the hinges 204 on the opposite side of the touchpad 202 that is coupled to the hinges 204, although any suitable type of sensor(s) described herein can be used. In addition, the touchpad 202 is secured to a supporting surface by two clamping devices 201 (e.g., screws, rivets, springs, etc.) to hold the touchpad 202 against the force transducer 206. It may be advantageous to secure the supporting surface to the touchpad 202 with a compliant clamping mechanism, such as a soft spring, rubber or foam material, etc., in order to moderate the amount of pre-compression force applied to the force transducer 206.

Alternatively (or in addition), and as discussed above, a biasing member may also be employed to bias the touchpad 202 against or towards the force transducer 206. Further, such biasing members may include one or more additional pivot mechanisms 104 that are coupled to an additional side or surface of the touchpad 202. In one example, such a biasing member may be a spring 210 that may be placed above the touchpad 202. In some examples, the spring 210 exerts a pre-compression force on the touchpad 202, pushing down on touchpad 202 to create the pre-compression force on force transducer 206. Further, in some examples the spring 210 may be another suitable device or pivot mechanism, e.g., a clamping device, an adhesive material, a leaf spring, a flexural member, an extension of the housing, or any other suitable mechanism described herein. By positioning the spring 210 or a biasing member in the center of the touchpad 202 the overall strength of the force sensor system 200a may be improved. In other examples, one or more biasing members may be located above or below the touchpad, at the corners of the touchpad, or at any other suitable location, using any suitable pattern or arrangement.

Further, in the example shown in FIG. 2A, the force transducer 206 is a contact sensor. However it should be appreciated that in this, or other examples, the force transducer 206 may be replaced by, or used in concert with, a non-contact pressure-sensing device, e.g., a Hall effect sensing device, a proximity sensor, an angular sensor, rotary encoder, torque sensor, displacement sensor, or another non-contact sensing mechanism, to detect an amount of force applied to surface.

Referring now to FIG. 2B, FIG. 2B shows an example of a side view of a force sensor system 200b similar to the example shown in FIG. 2A. However, in this example, two force transducers 206 are employed, although any suitable type of sensor(s) described herein can be used. The force transducers 206 are located at the respective corners of the side of the touchpad 202 that is located opposite the hinges 204, and the force transducers 206 being in constant contact with touchpad 202, e.g., based on a biasing member, one or more clamping devices, or the hinges 204 themselves. In this example, hinges 204 may be any suitable hinge(s), compliant member, or flexural member that is affixed to support surface 203 and cantilevers away from the support surface where the hinges 204 are affixed to support surface 203, allowing touchpad 202 to move towards the support surface 203 where the touchpad 202 is held in contact with force transducers 206.

Referring now to FIG. 2C, FIG. 2C shows another example of an overhead view of a force sensor system 200c similar to the examples shown in FIG. 2A and 2B. However, in this example, sensor 206a may be an angular sensor employed to determine a response of the surface of touchpad 202 to a contact by sensing an amount of rotational movement around the hinges 204. Thus, as more force is applied to the touchpad 202, the greater the rotation about the hinge. As can be seen, the sensor 206a is located on the side of the touchpad 202 that is coupled to the hinges 204 to detect the rotational movement. In this example, the applied force determines a response that is sent by a computing device (not shown) to a haptic output device 208. The haptic output device 208 may be coupled to (e.g., affixed to or contained within) the touchpad 202 to apply haptic effects to it.

In some examples, it may be advantageous to position the haptic output device 208 substantially in the center of the touchpad 202 and parallel to a substantially vertical plane of the hinges 204 and sensor 206a. Further, it may be advantageous to position the haptic output device 208 on axis A, which runs substantially perpendicularly through both the force sensor 206 and the center of the axis of rotation of the hinges 204. For example, as shown in FIG. 2C, the haptic output device 208 may be positioned substantially at the midpoint of the axis with respect to the touchpad 202. Further, in examples that employ a force sensor positioned on the opposite side of the touchpad 202 from the hinges' axis of rotation, such as shown in FIG. 2A, the haptic output device 208 may be positioned equidistant between either edge of the touchpad corresponding to the axis of rotation and the force sensor.

Positioning the haptic output device 208 along this axis, and substantially in the same plane as both the point of contact with the force sensor 206 and the hinges' axis of rotation, shows reductions in undesirable torques applied to the touchpad 202 about the hinges when the haptic output device 208 outputs haptic effects. These torques are created by inertial forces generated by the haptic output device 208. By reducing these torques, the positioning of the haptic output device 208 can reduce or eliminate transmission of vibrations in the direction of force sensing, e.g., vertically. This can provide a significant reduction in noise signals sensed by sensor 206a, thereby reducing or eliminating the need for software filtering of such signals.

For example, during a haptic effect having a vibration at 200 Hz, the sensor 206a would typically sense a noise signal at approximately 200 Hz because the haptic output device 208 causes both horizontal and vertical movement of the touchpad 202. But, by positioning the haptic output device 208 along axis A, e.g., at the midpoint of the axis, a perceived strength of a haptic effect can be maintained while reducing the magnitude of the 200 Hz vibrations sensed by sensor 206a. As discussed above such positioning mechanically reduces the torques caused by inertial forces during the haptic effect, which can reduce or effectively eliminate the need for traditional signal processing (e.g., low pass filtering, wavelet transformation calculations, de-noising algorithms, other linear or non-linear filtering techniques, or other statistical or software-based algorithms).

In some examples, sensor 206a may be another type of sensor to detect rotation or rotational forces, e.g., a proximity sensor, a rotary encoder, a torque sensor, a displacement sensor, or a non-contact sensing mechanism, such as a Hall-effect sensing device, to detect an amount of force applied to surface. It should be appreciated that the example shown in FIG. 2C may also include any of the additional devices employed herein. Further, other examples according to this disclosure may employ these sensors and techniques. Further, in some examples, the touchpad 202 may be a deformable surface that is able to output deformation haptic effects. It should be appreciated that the touchpad 202 itself may include, or be coupled to, other components than those discussed above, including one or more haptic output devices 208, one or more remote haptic output devices, one or more touch sensors, one or more LEDs, one or more PCBs, one or more display devices, etc.

Referring now to FIG. 3, FIG. 3 shows an underside view of an example force sensor system 300 for haptic surfaces. In this example, a flexural member 304 is employed instead of a rotatable hinge and is coupled to the underside of the touch surface 302. The touch surface 302 is also supported by a pressure sensor 306, which supports the edge of the touch surface 302 opposite the flexural member 304. In some examples however, a pressure sensor 306 may be located beneath a corner or corners of touch surface 302, at the midpoint of the same side, or another suitable location. Pressure sensor 306 may also include more than one pressure sensor.

In this example, the flexural member 304 includes a rigid material, such as a metal (e.g., steel), a composite fiber, or carbon fiber, to limit a range of motion of the touch surface 302. By limiting the amount of flexion, the flexural member 304 may help eliminate flexing of the touch surface 302 due to applied forces and limit a vertical range of motion at the pressure sensor. Such restrictions may enable more accurate force sensing. Further, while the flexural member 304 is shown as only extending partway across the touch surface 302, in some examples, the flexural member 304 may extend substantially the entire length and width of the touch surface 302 to provide further rigidity to the touch surface.

In this example, clamping devices 301 are used to affix the flexural member 304 to a support surface (not shown). As discussed above, clamping devices 301 may be any suitable device, an extension of the housing, or an adhesive used to affix a pivot mechanism to the support surface in a suitable manner. In this example, two clamping devices 301 are depicted as screws that are placed a substantially similar distance from the ends of the flexural member 304. In some examples, more clamping devices may be used, or the distance between the clamping devices 301 may be predetermined based on the rigidity of the material of the flexural member 304.

In this example, the pressure sensor 306 is coupled to the opposite side of the touch surface 302 from the location of the flexural member 304. Such a placement allows the flexural member 304 to act as a rotatable member, e.g., as a pivot mechanism, such that the displacement at the pressure sensor 306 due to an applied force is greater than the displacement, if any, at the lever arm.

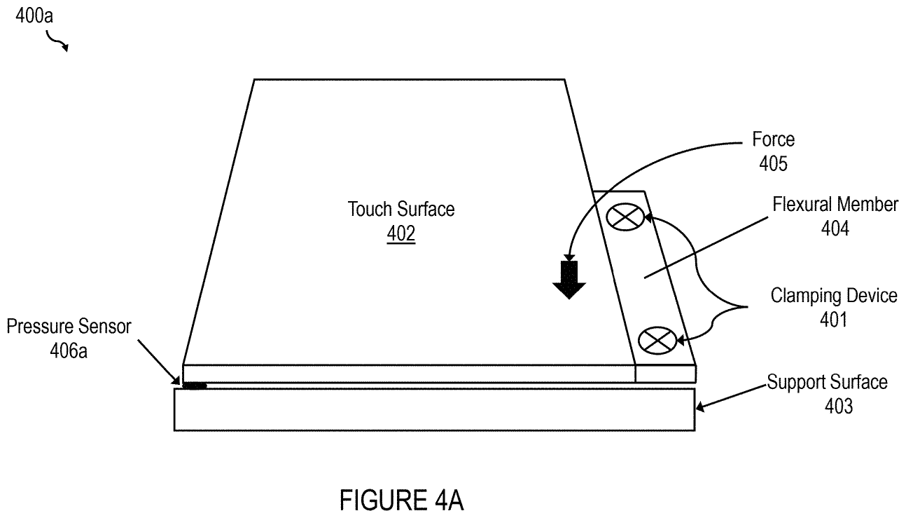

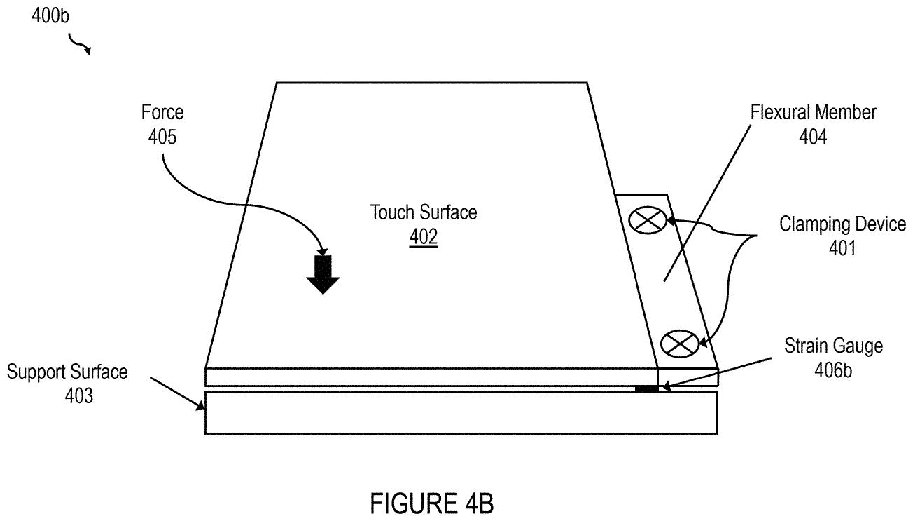

Referring now to FIG. 4A, FIG. 4A shows another example of a force sensor system 400a for haptic surfaces employing a flexural member 404. In this example, a pressure sensor 406a is positioned on the opposite side of the touch surface 402 that is coupled to flexural member 404, although any suitable type of sensor(s) described herein can be used. As discussed above with respect to FIG. 3, the flexural member 404 may be made of spring steel, carbon fiber, a composite fiber, or another rigid material and is clamped to the touch surface 402 by one or more clamping devices, e.g., clamping devices 401. In this example, flexural member 404 is affixed to support surface 403 and cantilevers away from the support surface where the flexural member 404 is affixed to support surface 403, allowing touch surface 402 to move towards the support surface 403 in response to an applied force 405, where the touch surface 402 is held in contact with the pressure sensor 406a.

Additionally, as discussed above, the use of a flexural member 404 to connect the touch surface 402 in combination with the pressure sensor 406a may help reduce the size and number of components of the force sensor system 400a, such as by eliminating the need to use hinges or other complex rotatable joints. Further, using such materials may help reduce the weight of example sensors. Materials such as a thin sheet of steel or carbon-fiber may provide suitable rigidity while also providing weight savings by eliminating other components, such as hinges, biasing members, etc. It should be appreciated that a flexural member 404 employing such rigid materials may strengthen the sensor system by removing any play, backlash, unwanted reverberations, or compliance in the assembly. Such added strength and rigidity due to the inelasticity of the flexural member 404 ensures the force sensor system 400a mitigates and/or eliminates substantially all potential hysteresis resulting from the pivot mechanism or compliance in the surface itself. For example, if the touch surface 402 does not return to its at-rest configuration after user contact ends, the pressure sensor 406a may still register an applied force. Thus, maintaining rigidity in the surface and pivot mechanism structure may enable consistent, repeatable force sensing output over time.

Referring now to FIG. 4B, FIG. 4B shows another example of a force sensor system 400b for haptic surfaces employing a flexural member 404. In this example, a strain gauge 406b is positioned on the same side of the touch surface 402 that is coupled to flexural member 404, although any suitable type of sensor(s) described herein can be used. As discussed above, the flexural member 404 may be made of a rigid material and is clamped to the touch surface 402 by one or more clamping devices, e.g., clamping devices 401. In some examples, more than one strain gauge may be positioned on more than one side of the touch surface 402, e.g., the side of the touch surface 402 that is coupled to the flexural member 404 is shown having a strain gauge placed on that same side, while a second strain gauge could be placed on the opposite side of the touch surface 402. Further, while the strain gauge 406b is positioned at a particular location in this example, it should be appreciated that one or more strain gauges may be positioned at any location, such as beneath the flexural member 404 or between the flexural member 404 and the touch surface 402. In this example, flexural member 404 is affixed to support surface 403 and cantilevers away from the support surface where the flexural member 404 is affixed to support surface 403, allowing touch surface 402 to move towards the support surface 403 in response to an applied force 405, where the touch surface 402 is held in contact with the strain gauge 406b.

Referring now to FIG. 5A, FIG. 5A shows multiple viewing angles for another example of a force sensor system 500a for haptic surfaces employing a double-hinge mechanism 504. In the example shown in FIG. 5A, the force sensor system 500a includes a surface 502 that is not touch sensitive (e.g., it lacks touch-sensing capabilities and/or is passive). For example, the surface 502 may be a plastic surface, a display, button, gear shifter, steering wheel, dashboard, etc. But other examples may involve the surface 502 being touch sensitive, for instance if the surface 502 is a touch-screen display or touch pad.

The surface 502 is coupled to a support structure 503 by two pivot mechanisms, the support structure 503 having one or more support surfaces. And, in general, a support structure may have one or more support surfaces. In this example, the pivot mechanisms are double-hinge mechanisms 504. Each double-hinge mechanism 504 includes two hinges coupled to an elongated member 513 (e.g., at opposite ends of the elongated member 513). In some examples, one of the hinges couples the surface 502 to the elongated member 513, while the other of the hinges couples the elongated member 513 to the support structure 503, thereby coupling the surface 502 to the support structure 503. However, in other examples, the double-hinge mechanism 504 may couple the surface 502 to the support structure 503 in any suitable manner.

Although described herein as a “double-hinge mechanism” for ease, it will be appreciated that a “double-hinge mechanism” need not specifically include two hinges, but can instead employ two of any type of pivot mechanism described herein, or any combination of pivot mechanisms described herein, separated by elongated member 513. For example, the double-hinge mechanism 504 may include one or more flexural members, such as one or more pieces of sheet metal (e.g., steel), a leaf spring, plastic, a suitable polymer, carbon fiber, a composite fiber, or any combination thereof, that is affixed to the support structure 503 and cantilevers away from the support structure 503. The surface 502 is held flat by the double-hinge mechanisms 504, in a substantially horizontal plane parallel to the support structure 503.

Two force sensors 506 are shown positioned on opposing sides of the support structure 503 to one another, although any suitable type of sensor(s) described herein can be used. The force sensors 506 are positioned on sides of the support structure 503 that are substantially perpendicular to the sides of the support structure 503 along which the double-hinge mechanisms 504 are aligned. The force sensors 506 shown can include any contact or contactless pressure sensing device suitable to measure force and output corresponding sensor signals. In some examples, the force sensor system 500a may also include a spring, a clamping device, a haptic output device, or any combination thereof. Such springs, clamping devices, haptic output devices may be arranged according to any suitable example discussed herein.

In some examples, the double-hinge mechanism 504 allows the hinges to operate in concert to provide an isostatic mechanism. At rest, the double-hinge mechanism 504 maintains the flat plane of the surface 502, restricting motion of the surface 502 in a horizontal direction. In operation, the double-hinge mechanism 504 allows the surface 502 to move freely in a vertical direction and, in this example, the double-hinge mechanism 504 also allow the surface 502 to tilt. Thus, an isostatic mechanism is created by matching the two constraining double-hinge mechanisms 504 to the number of degrees of freedom. Such freedom of motion may increase the accuracy of force sensing by force sensors 506 by reducing the resistance of a frame constraint. The lack of torque and resistance from an applied frame constraint allows force sensors 506, which are co-planar to surface 502, to independently sense one or more forces applied to the surface 502. The strength and rigidity of the double-hinge mechanisms 504, acting together, provides rigidity to the structure of the force sensor system 500a, while also removing the potential for jamming, loosening, wobbling, or any other instability. Thus, when a user applies a force to surface 502, the double-hinge mechanisms 504 may allow the surface 502 to move in a substantially vertical direction and around or about a fixed axis. In this example, the hinges of double-hinge mechanism 504 may be any suitable hinge(s), compliant member, or flexural member that are affixed to the support structure 503 and simultaneously cantilevers away from the support structure 503 where the hinges of double-hinge mechanism 504 are affixed to the support structure 503, allowing surface 502 to move towards the support structure 503 where the surface 502 is held in contact with the force sensors 506.

In some examples, the elongated members 513 of the double-hinge mechanism 504 can be replaced by flexural members arranged as the elongated members 513 illustrated in FIGS. 5A. The flexural members may be fixedly coupled at one end to the support structure, and fixedly coupled at the other end to the surface 502. Each coupling location, both at the surface and at the support structure, provides a pivot point about which the flexural members may deflect (i.e., pivot).

As discussed above, the force sensors 506 sense a response of the surface 502 to contact. In some examples, the two force sensors 506 can determine the location of an applied force to the surface 502 based on the amount of force applied to one of the two sensors, independent of (or absent) data from the surface 502 (e.g., since the surface 502 lacks touch-sensing capabilities). For example, when a user contacts the surface 502, the location of the applied force may be determined based on a comparison of pressure readings sensed by the two force sensors 506. By comparing the pressure readings, the general location of a user interaction can be determined based on one of the force sensors 506 reporting a greater amount of force than the other of the force sensors 506. This is due to the location of a user interaction being in closer proximity to the force sensor 506 that reports the higher pressure reading. This may be particularly useful for detecting interactions with buttons associated with opposite ends of the surface 502, since the majority of an applied force will be sensed proximate to one of the ends of the surface 502. Thus, some examples can be implemented as an alternative to traditional touch surfaces and in systems that lack traditional touch surfaces.

In some examples, a computing device can additionally or alternatively determine a total force applied to the surface 502 just by using data from the force sensors 506 (e.g., absent data from the surface 502). For example, the double-hinge mechanism 504 holds the surface 502 horizontally in place while allowing the surface 502 to freely move vertically and about an axis, and such freedom of movement increases the accuracy of the force sensors 506. By eliminating horizontal movement, the increased accuracy of the pressure readings may enable a total applied force of one or more touch inputs to be ascertained based on the distance between the location of the contact and the double-hinge mechanism(s) 504. In one such example, a total amount of force applied to surface 502 may be calculated by summing the pressure readings reported by the two force sensors 506.

Referring now to FIG. 5B, FIG. 5B shows another example of multiple viewing angles for a force sensor system 500b similar to the example shown in FIG. 5A. As discussed above, the surface 502 is coupled to a support structure 503 in part by two elongated members 513, the support structure 503 having one or more support surfaces. Each elongated member has two hinges. In some examples, one of the hinges couples the surface 502 to the respective elongated member 513, while the other of the hinges couples the respective elongated member 513 to the support structure 503, thereby coupling the surface 502 to the support structure 503. Further, in some examples, the double-hinge mechanism 504 can be replaced by one or more flexural members. In such a configuration, the parallel flexural members would occupy substantially similar positions as the elongated members 513 and would deflect and pivot about the respective coupling locations in response to an applied force, as discussed above with respect to FIG. 5A.

In this example, surface 502 rests atop of suspension pads 509, which may be coupled to (e.g., affixed to or contained within) a suspension 511 by a clamping device, e.g., an adhesive device (not shown) or any other suitable device. Further, the substantially similar support structure 503 (having one or more support surfaces) is coupled to suspension 511, which includes a substantially flat surface that may contact force sensors 506. Additionally, suspension 511 provides parallel horizontal surfaces for suspension pads 509 that are coupled to surface 502. In this example, suspension 511 is shown having four protrusions supporting four suspension pads. However, in some examples, suspension 511 may be coupled to any number of suspension pads 509. Further, the suspension pads 509 may be made of any suitable material such as silicon, a polymer, an elastomer, paraffin wax, etc. In some examples, the suspension 511 may be made of a suitable rigid material, e.g., steel, carbon fiber, a composite fiber, a suitable polymer, etc.

An actuator 508 is coupled to the surface 502 for providing haptic effects. For example, as depicted in the underside view shown in the lower left corner of FIG. 5B, the actuator 508 can extend at least partially through a cutout in a suspension 511, such that the actuator 508 does not contact the suspension 511. In some examples, the actuator 508 may be in contact with, or minimally contact, the suspension 511, in order to prevent the suspension 511 from reducing the strength, frequency, response time, etc. of haptic effects produced by the actuator 508. However, in some examples, it may be advantageous to couple the actuator 508 to the suspension 511, such as to increase the overall rigidity, durability, or structural integrity of the force sensor system 500b.

The suspension 511 is positioned in a horizontal plane parallel to, and in between, the support structure 503 and the surface 502. In this example, the double-hinge mechanisms 504 are coupled to support structure 503 and suspension 511, allowing the actuator 508 to contact the surface 502 to provide haptic effects while suspended separately, and above, support structure 503. Such separation may be advantageous to increase perceived strength or intensity of haptic effects, while reducing the size and expense of a surface 502 with an internal haptic output device. In some examples, the suspension 511 may be integrated with one or more of the double-hinge mechanisms 504. For example, the suspension 511 shown in FIG. 5B is pivotably coupled to the elongated member 513, which is pivotably coupled to the support structure 503. In other examples, the suspension 511 may be integrated with, or coupled to, the double-hinge mechanism 504 by one or more knuckles, leafs, pins, members, beams, clamping devices, or any other suitable means discussed herein.

It should be appreciated that the example shown in FIG. 5B may also include any of the support surfaces, clamping devices, or pivot mechanisms employed herein. Further, other examples according to this disclosure may employ these sensors and techniques. In some examples the actuator 508 may be any suitable haptic output device, for example, one or more of a piezoelectric actuator, an electric motor, an electro-magnetic actuator, a voice coil, an electro-active polymer, a solenoid, an eccentric rotating mass motor (“ERM”), a spinning or scalable rotary actuator (“SRA”), an ultrasonic actuator, a deformation device, an electrostatic actuator, a shape memory material, a solenoid resonance actuator, etc.

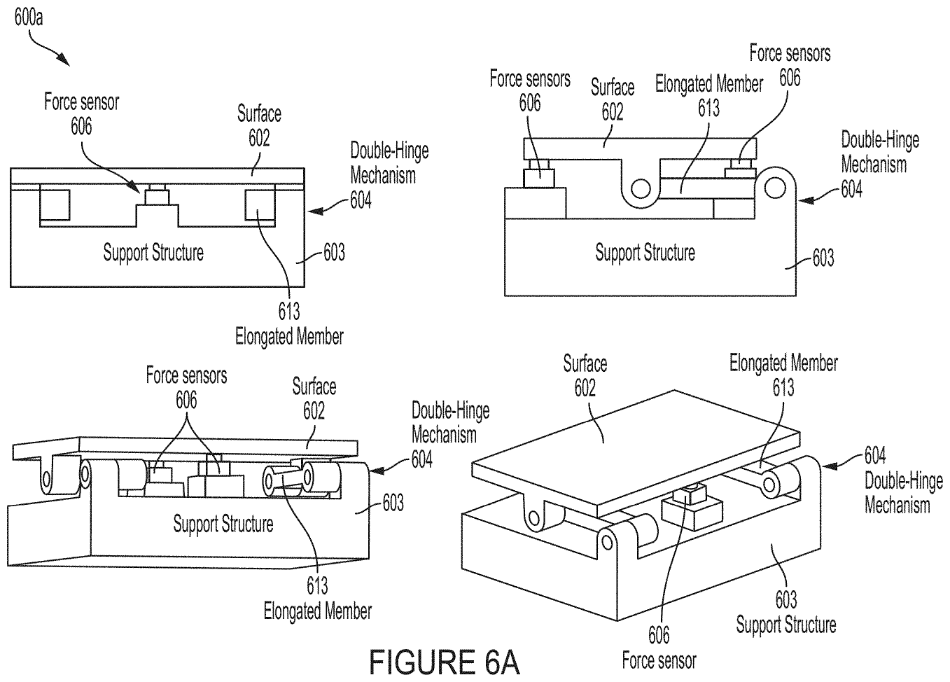

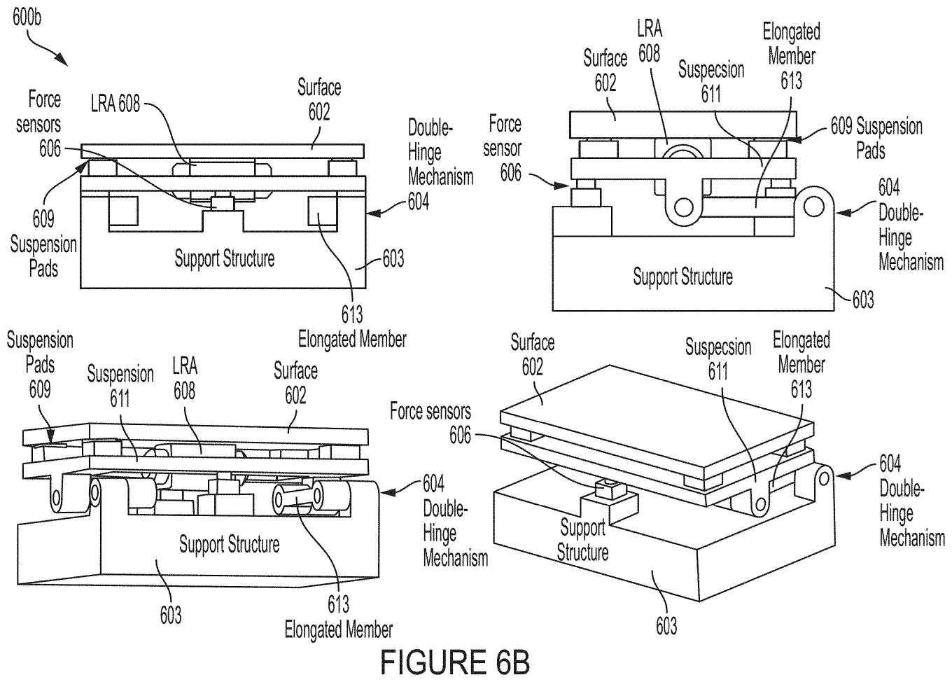

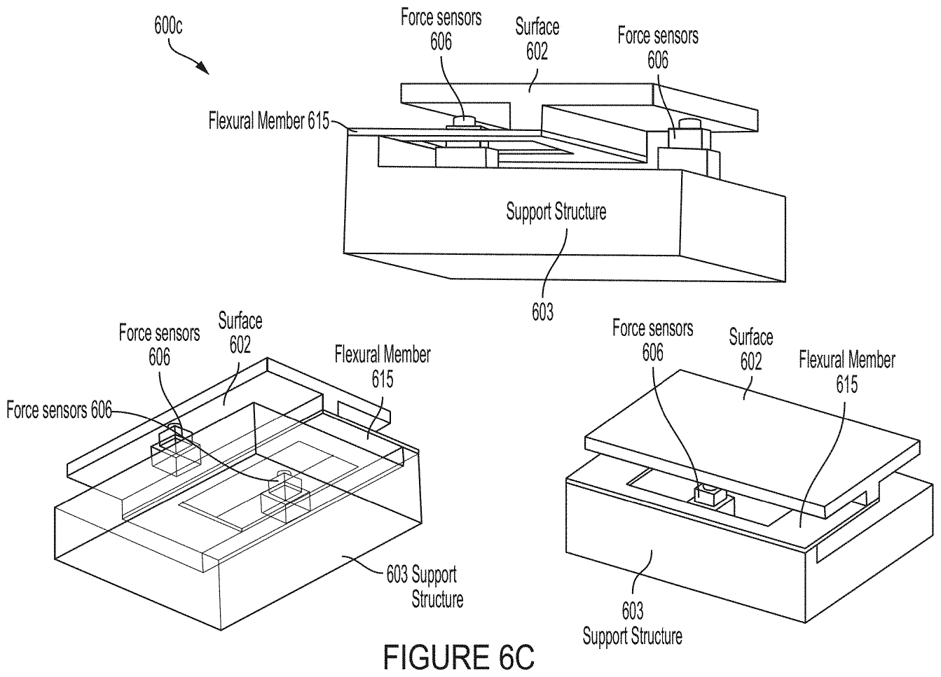

Referring now to FIG. 6A, FIG. 6A shows another example of multiple viewing angles of another example of a force sensor system 600a for haptic surfaces employing a centered, double-hinge mechanism 604. In the example shown in FIG. 6A, the force sensor system 600a includes a surface 602 that is not touch sensitive (e.g., it lacks touch-sensing capabilities and/or is passive). For example, the surface 602 may be a plastic surface, a display, button, gear shifter, steering wheel, dashboard, etc. But other examples may involve the surface 602 being touch sensitive, for instance if the surface 602 is a touch-screen display or touch pad.

The surface 602 is coupled to another pivot mechanism—a centered double-hinge mechanism 604, in which one of the hinges of the centered double-hinge mechanism 604 is coupled at a point substantially centered with respect to a width of the substantially parallel surface 602, where the width represents the dimension running between the force sensors 606. Such a substantially centered position of one of the hinges of the centered double-hinge mechanism 604 provides a pivot point enabling the surface 602 to rotate about a substantially central axis of rotation. This centered double-hinge mechanism 604 also couples the surface 602 to opposing sides of a support structure 603 having one or more support surfaces. Similar to the double-hinge mechanism 504 shown in FIG. 5A, the double-hinge mechanism 604 also includes two hinges coupled to an elongated member 613 (e.g., at opposite ends of the elongated member 613).

In some examples, one of the hinges couples the surface 602 to the elongated member 613, while the other of the hinges couples the elongated member 613 to the support structure 603, thereby coupling the surface 602 to the support structure 603. In other examples, it may be advantageous to couple the one of the hinges of the centered double-hinge mechanism 604 at a point substantially centered with respect to widths of both surface 602 and the support structure 603, the surface 602 and support structure 603 having substantially similar widths, in order to improve the overall structural integrity of force sensor system 600a. However, in some examples, the width of support structure 603 may be substantially wider than the respective width of the surface 602, such that the one of the hinges of the centered double-hinge mechanism 604 is substantially centered at a pivot point of the surface 602 and not substantially centered with respect to the support structure 603.

Two force sensors 606 are shown in this example as being positioned on opposing sides of support structure 603 from one another, although any suitable type of sensor(s) described herein can be used. The force sensors 606 are positioned on sides of the support structure 603 that are substantially perpendicular to the sides of the support structure 603 along which the centered double-hinge mechanisms 604 are aligned. The surface 602 is held flat, in a substantially horizontal plane parallel to the support structure 603. In this example, the reduced length of the hinges of the centered double-hinge mechanism 604 may provide a weight reduction to the overall structure of the force sensor system 600a without sacrificing the rigidity of the two centered double-hinges of the centered double-hinge mechanism 604. Further, such a centered double-hinge mechanism 604 corresponds to an axis of rotation substantially in the center of the support structure 603, which allows for a greater range of motion for the tilt freedom.

Referring now to FIG. 6B, FIG. 6B shows another example of multiple viewing angles for another example of a force sensor system 600b for haptic surfaces employing a centered double-hinge mechanism 604. As discussed above, the surface 602 is coupled to a support structure 603 in part by two elongated members 613, the support structure 603 having one or more support surfaces. FIG. 6B shows a similar force sensor system 600b to that of FIG. 6A. However, in this example, surface 602 rests atop of suspension pads 609, which may be coupled to a suspension 611 by a clamping device, e.g., an adhesive device (not shown) or any other suitable device. Further, in this example, the substantially similar support structure 603, having one or more support surfaces, is coupled to suspension 611, which includes a substantial flat surface that may contact force sensors 606. Additionally, suspension 611 provides parallel horizontal surfaces for suspension pads 609 that are coupled to the surface 602.

As discussed above, the suspension 611 may be integrated with one or more of the double-hinge mechanisms 604 and pivotably coupled to elongated member 613, e.g., the suspension 611 may be integrated with, or coupled to, the double-hinge mechanism 604 by one or more knuckles, leafs, pins, members, beams, clamping devices, or any other suitable means discussed herein. And in this example, suspension 611 is shown having four surfaces for four suspension pads. However, in some examples, suspension 611 may be coupled to any number of suspension pads 609. Further, the suspension pads 609 may be made of any suitable material such as silicon, a polymer, an elastomer, paraffin wax, etc. In some examples, the suspension 611 may be made of a suitable rigid material, e.g., steel, carbon fiber, a composite fiber, a suitable polymer, etc. Further, in some examples, the double-hinge mechanism 604 can be replaced by one or more flexural members, as discussed above with respect to FIG. 5A.

A linear resonant actuator (“LRA”) 608 is coupled to the surface 602, though any type of haptic output device may be used. For example, the LRA 608 may be replaced by, or used in concert with another haptic output device, for example, one or more of a piezoelectric actuator, an electric motor, an electro-magnetic actuator, a voice coil, an electro-active polymer, a solenoid, an eccentric rotating mass motor (“ERM”), a spinning or scalable rotary actuator (“SRA”), an ultrasonic actuator, a deformation device, an electrostatic actuator, a shape memory material, a solenoid resonance actuator, etc. The LRA 608 is positioned in a horizontal plane parallel to, and in between, the support structure 603 and the surface 602. In some examples, the LRA 608 may extend at least partially through a cutout in the suspension 611, for example as discussed above with respect to the actuator 508 of FIG. 5B.

In this example, a centered double-hinge mechanism 604 couples the support structure 603 to the suspension 611, allowing the LRA 608 to contact the surface 602 to provide haptic effects separately. Such separation may be advantageous to increase perceived strength or intensity of haptic effects, while reducing the size and expense of a system with an internal haptic output device. In some examples, the greater range of motion associated with the tilt freedom may aid in determining the location of a sensed force, where the majority of the sensed force is associated with one of the two opposing force sensors 606, may correspond to a bidirectional button-press, e.g., an up or down button. It should be appreciated that the example shown in FIG. 6B may also include any of the support surfaces, clamping devices, or pivot mechanisms employed herein.

Referring now to FIG. 6C, FIG. 6C shows another example of multiple viewing angles for another example of a force sensor system 600c for haptic surfaces employing a centered pivot mechanism. In this example, the surface 602 is coupled to a support structure 603 in part by flexural member 615, the support structure 603 having one or more support surfaces. FIG. 6C also shows a similar force sensor system 600c to those of FIGS. 6A and 6B. However, in this example, surface 602 rests atop of flexural member 615, which may be coupled to the support structure 603 by a clamping device, e.g., an adhesive device (not shown) or any other suitable device. Force sensors 606 are coupled to an integrated, substantially flat surface of the support structure 603.

As discussed above with respect to FIGS. 5A and 5B, the double-hinge mechanism 604 can be replaced by one or more flexural members. In this example, a substantially rectangular-shaped flexural member 615 serves as a pivot mechanism by coupling with the surface 602. In this example, the flexural member 615 is coupled to the surface 602 at a location that is substantially along a centerline of the surface 602, though any suitable coupling location may be employed. The flexural member 615 includes two planks that couple to and extend from the support structure 603 and couple to the surface 602, as well as two cross-members to form the rectangular shape.

While this example illustrates a flexural member 615 that has a rectangular configuration, in some examples, one or both of the cross-members may be omitted. For example, both cross-members may be omitted to reduce an overall weight of the force sensor system 600c.

The flexural member 615 illustrated in FIG. 6C allows the surface 602 to rotate about an axis of rotation that runs along the cross-member coupled to the surface 602. Such a configuration may enable a “rocker” style movement of the surface 602. While the flexural member in this example provides a specific configuration, in some examples, the flexural member 615 may comprise one or more planks, coupling one or more portions of the support structure 603 to the surface 602 by any suitable means discussed herein. Further, by coupling the flexural member 615 to the surface 602 at points that are substantially centered between force sensors 606, the flexural member 615 holds the surface 602 horizontally in place while allowing the surface 602 to freely move vertically and about an axis of rotation (providing a rocker-style movement), and apply forces to the force sensors 606. Such freedom of movement may further increase the accuracy of the force measurements obtained by the force sensors 606.

As discussed above, one advantage of employing a flexural member is the increased rigidity that results in the overall structure. And in this example, the flexural member 615 has sufficient rigidity to hold the surface 602 rigidly in place, substantially maintaining a horizontal plane during a user interaction or other contact. This rigidity may be improved by the flexural member 615 having the substantially rectangular shape (e.g., as opposed to being two independent flexural members), thereby enabling the force sensors 606 to be positioned substantially closer to the centroid of the surface 602 in some examples. Such positioning of the force sensors 606 may advantageously increase the sensitivity of the force sensors, reducing the vertical distance required to be depressed by the force sensors 606 to accurately detect an applied force. The increased rigidity can further eliminate horizontal movement of the surface 602, which can increase the accuracy of the force sensors 606 when combined with the substantially centered, singular axis of rotation afforded by the flexural member 615. Such an increased accuracy in pressure readings may enable a total applied force of one or more touch inputs to be ascertained based on the distance between the location of the contact and the closest side of support structure 603 in proximity to the one or more touch inputs. In one such example, a total amount of force applied to surface 602 may be calculated by summing the pressure readings reported by the two force sensors 606. While a substantially rectangular flexural member 615 is shown in FIG. 6C, it should be appreciated that one or more flexural members may be employed to couple the surface 602 and the support structure 603 with any of the techniques discussed herein.

In some examples, an actuator (not shown) may be coupled to the surface 602 for providing haptic effects. In this example, the underside view of the force sensor system 600c shows a cutout, through which one or more actuators may extend, at least partially, such that an actuator would not contact support structure 603, in order to prevent the support structure 603 from impacting haptic effects produced by such an actuator. In some examples, an actuator may be in contact with, or minimally contact, the support structure 603. Examples of the actuator may be a linear resonant actuator (“LRA”), though any type of haptic output device may be used. For example, the LRA 608 may be replaced by, or used in concert with another haptic output device, for example, one or more of a piezoelectric actuator, an electric motor, an electro-magnetic actuator, a voice coil, an electro-active polymer, a solenoid, an eccentric rotating mass motor (“ERM”), a spinning or scalable rotary actuator (“SRA”), an ultrasonic actuator, a deformation device, an electrostatic actuator, a shape memory material, a solenoid resonance actuator, etc.

As discussed above, the flexural member 615 couples the support structure 603 to the surface 602, which may allow an actuator (not shown) to contact the surface 602 to provide haptic effects separately. Such separation may be advantageous to increase perceived strength or intensity of haptic effects, while reducing the size and expense of a system with an internal haptic output device. In some examples, the centered position of the flexural member 615 can afford a greater degree of tilt freedom and correspondingly a greater range of motion. This may aid in determining the location of a sensed force, where the majority of the sensed force is associated with one of the two opposing force sensors 606. Such a majority of the sensed force may correspond to a bidirectional button-press, e.g., an up or down button. It should be appreciated that the example shown in FIG. 6C may also include any of the support surfaces, clamping devices, suspensions, suspension pads, members, force sensors, or pivot mechanisms employed herein.

The examples shown in FIGS. 5A-B and 6A-6C may also be combined with other aspects and features of the present disclosure. For instance, while the examples in FIGS. 5A-5B and 6A-6C above were described as using surfaces lacking touch-sensing capability, in some examples, the surface (e.g., surface 502 or 602) may include a touch surface (e.g., touch pad). In some such examples, various techniques described herein in relation to touch surfaces and data obtained therefrom, e.g., a location (or locations) of contact with the surface, may be employed as described herein. Further, other examples according to this disclosure may employ the features and techniques described in these figures.

Referring now to FIG. 7, FIG. 7 shows a block diagram of an example system including a force sensor for haptic surfaces 702. In the example shown in FIG. 7, the force sensor system 700 includes a haptic surface 702 that is coupled to a hinge 704 at one side of the haptic surface 702. In this example, the side of the haptic surface 702 opposite to the side coupled to the hinge 704 rests on a force sensor 706, thereby exerting a baseline force on the force sensor 706 as discussed above. The haptic surface 702 itself includes one or more sensors to enable the surface to a contact with the surface and provide one or more signals indicating the location of the contact, such as an (x, y) coordinate of the contact. Further, in this example, a haptic output device 708 is in communication with the haptic surface 702 to apply haptic effects to it. Further, in some examples, the haptic surface 702 may be a deformable surface that is able to output deformation haptic effects. It should be appreciated that the haptic surface 702 itself may include, or be coupled to, other components than those discussed above, including one or more haptic output devices, one or more remote haptic output devices, one or more touch sensors, one or more LEDs, one or more PCBs, one or more display devices, etc.

In this example, the computing device 710 is communicatively coupled to haptic surface 702 and force sensor 706 to receive signals from each. In this example, the computing device 710 determines the force F 705 applied by a user interaction of the haptic surface 702. In addition, the computing device 710 is in communication with the haptic output device 708 to allow the computing device to output haptic effects to the haptic surface 702 using the haptic output device 708. And while only one haptic output device 708 is shown in this example, any suitable number or type of haptic output device may be employed.

While FIG. 7 shows a haptic surface 702 communicatively coupled to computing device 710, in some embodiments, the computing device 710 may include the haptic surface 702 (e.g., a smartphone, tablet, etc.). In some examples, the haptic surface 702 can include any suitable number, type, or arrangement of touch sensors such as, for example, resistive and/or capacitive sensors that can be embedded in haptic surface 702 and used to determine the location of a touch and other information about the touch, such as pressure, speed, and/or direction. In one example, the computing device 710 can be a smartphone that includes the haptic surface 702 (e.g., a touch-sensitive screen) and a touch sensor of the haptic surface 702 can detect user input when a user of the smartphone touches the haptic surface 702.

In this example, as discussed above, the force sensor system 700 includes a haptic output device 708 in communication with the computing device 710. The haptic output device 708 is configured to output a haptic track or haptic effect to the haptic surface 702 in response to one or more haptic signals. For example, the haptic output device 708 can output a haptic track in response to a haptic signal from a processor (not shown) of the computing device 710. In some examples, the haptic output device 708 is configured to output a haptic track comprising, for example, a vibration, a change in perceived coefficient of friction, a simulated texture, an electrotactile effect, a surface deformation (e.g., a deformation of a surface associated with the computing device 710), and/or a puff of a solid, liquid, or gas. Further, some haptic tracks may use multiple haptic output devices 708 of the same or different types in sequence and/or in concert.

Although a single haptic output device 708 is shown in FIG. 7, some embodiments may use multiple haptic output devices of the same or different type to produce different haptic effects. In some embodiments, the haptic output device 708 may be internal or external to computing device 710 and in communication with the computing device 710 (e.g., via wired interfaces such as Ethernet, USB, IEEE 1394, and/or wireless interfaces such as IEEE 802.11, Bluetooth, radio interfaces, cellular signal 5G, etc.). For example, the haptic output device 708 may be associated with (e.g., coupled to or within) the computing device 710 and configured to receive haptic signals from the computing device.

The haptic output device 708 may comprise, for example, one or more of a piezoelectric actuator, an electric motor, an electro-magnetic actuator, a voice coil, a shape memory alloy, an electro-active polymer, a solenoid, an eccentric rotating mass motor (“ERM”), a linear resonant actuator (“LRA”), a spinning or scalable rotary actuator (“SRA”), an ultrasonic actuator, a piezo-electric material, a deformation device, an electrostatic actuator, a shape memory material, which includes a metal, polymer, or composite, or a solenoid resonance actuator. In some embodiments, the haptic output device 708 comprises fluid configured for outputting a deformation haptic effect (e.g., for bending or deforming a surface associated with the computing device 710). In some embodiments, the haptic output device 708 comprises a mechanical deformation device. For example, in some embodiments, the haptic output device 708 may comprise an actuator coupled to an arm that rotates a deformation component. The actuator may comprise a piezo-electric actuator, rotating/linear actuator, solenoid, an electroactive polymer actuator, macro-fiber composite (“MFC”) actuator, shape-memory alloy (“SMA”) actuator, and/or other actuator. As used herein, the term “MFC element” is used to refer to a component or element that acts as both an actuator and a sensor.

In some embodiments, the computing device 710 can include a user device that can be, for example, a mobile device (e.g., a smartphone), smartwatch, a head-mounted display, a wearable device, a handheld device (e.g., a tablet, video game controller), or any other type of user interface device. In some examples, the user device can be any type of user interface device that can be used to provide content (e.g., texts, images, sounds, videos, a virtual or augmented reality environment, etc.) to a user. In some examples, the user device can be any type of user interface device that can be used to interact with content (e.g., interact with a simulated reality environment, such as, an augmented or virtual reality environment).

In some examples, a specific user interaction may have one or more associated haptic tracks. For example, correspondences between one or more user interactions and one or more haptic tracks may be stored in lookup tables or databases. Each haptic track may include haptic information and be associated with one or more user inputs, such as an amount of pressure, a location of the user input, a pattern of inputs, etc. in the applied force(s) associated with the user interaction(s), and each interaction may be associated with one or more haptic tracks. A haptic track can include a haptic effect (e.g., a vibration, a friction effect, a deformation effect, a thermal effect, etc.) or a series of haptic effects that correspond to the user interaction. For example, a user interaction associated with a press and hold event may have one haptic track (e.g., a user input of a thumbprint may have an vibrotactile haptic track), while a user input of a finger press and patterned movement may have a different haptic track (e.g., a friction haptic track) or a combination of haptic tracks.

It should be appreciated that while haptic tracks above have been described as including haptic information about multiple haptic effects, a haptic track may include only a single haptic effect, or may only reference haptic effects that are stored at another location, such as within a haptic library or stored remotely at a server.

In some examples, to the computing device 710 may monitor the haptic surface 702 for a location of a user interaction. When a user interacts with haptic surface 702, the computing device 710 receives location and force signals from haptic surface 702 and force sensor 706, respectively. The computing device 710 then executes program code or instructions to determine an amount of force applied to the haptic surface 702. In addition, the computing device 710 may executes program code or instructions to determine a haptic effect associated with the signal(s) from the haptic surface 702 and force sensor 706 based on a user interaction that corresponds to a specific haptic effect. After such a determination is made, a signal may be sent to the haptic output device 708 to generate and output the haptic effect associated with the user interaction. Haptic output device 708 may output, for example, a vibrotactile effect, an electrostatic effect or any other haptic effect.

Referring again to FIG. 7, a user may interact with the touch surface by applying a force F 705 to the touch surface. When the user applies an amount of force F 705 to the touchpad, a different amount of force Fₜ 707 is sensed by the force sensor 706. After detecting the user interaction, the location of the user interaction is output by the haptic surface 702 and the force Fₜ 707 is output by the force sensor 706. The sensed location data and force data output by the haptic surface 702 and force sensor 706 is sent to computing device 710.

In this example, the computing device 710, after receiving the signals from the force sensor 706 and the haptic surface 702, the computing device 710 executes program code to determine the distance a between the hinge 704 and the location of the user interaction where force F 705 was sensed. In addition, the computing device 710 may execute program code that calculates the applied force F 705 to determine the amount of force F 705 at the location of the user interaction.

In this example, the computing device 710 executes an algorithm to calculate the force F 705 of the user interaction with haptic surface 702 at the location indicated by the force sensor as follows. To determine the applied force F 705, the computing device 710 calculates the applied force using the expressions below.

$$\sum {M}_{H i n g e} = - a F + b {F}_{t} = 0 \\ ∴ aF = b {F}_{t} \\ ∴ F = \frac{b}{a} {F}_{t}$$

Thus, based on the sensed force and the location of the contact, the applied force may be determined. Further, in some examples, the haptic surface 702 is a multi-touch surface that reports multiple locations associated with the user interaction, and the computing device 710 may calculate a total applied force based on an average location associated with the multiple locations reported to the computing device. For example, the computing device may compute a centroid for a region bounded by straight lines connecting at vertices corresponding to each contact point. In some example, the computing device may compute an arithmetic average of each of the x and y coordinates, respectively, to determine an average location. Such a calculation may be used to determine the total calculated force applied to the haptic surface 702 based on the applied force(s) associated with each location or the average location.

It should be appreciated that the computing device may filter noise from data associated with the measurement of force from the force transducer signal. In this example, the processor may filter noise that exceeds a previously specified amount of noise. For example, noise that would be sufficient to be perceptible by a user may be filtered out to avoid detecting forces based one an applied haptic effect. Such noise instead may be distortion caused by the size of the touch surface or the amount of vertical movement of the force transducer.

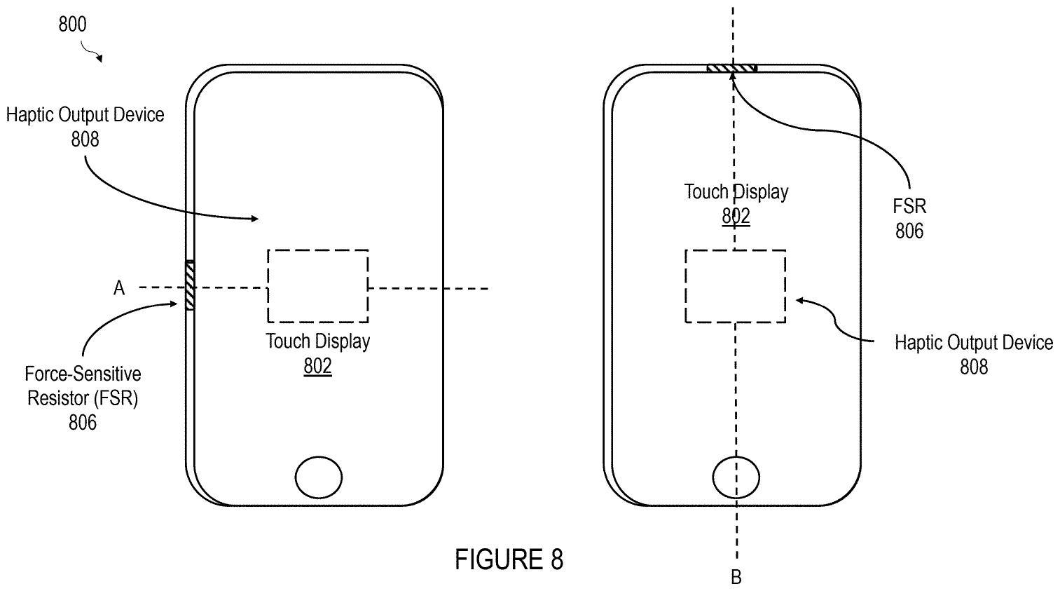

Referring now to FIG. 8, FIG. 8 shows an example force sensor system 800 of the present invention. In this example, force sensor system 800 includes a touch display 802 of a smartphone device, illustrated at a slightly angled perspective, which is in contact with force-sensitive resistor (“FSR”) 806, haptic output device 808, and an affixed to a pivot mechanism (not shown). In this example, the FSR 806 is proximate to a side of the three-dimensional smartphone device to illustrate that the FSR 806 may be positioned in a plane between a support surface or a support structure (not shown) and the touch display 802. Alternatively (or in addition to), the FSR 806 may be integrated within, proximate to, or coupled to the touch display 802 in any other suitable arrangement.

In this example, haptic output device 808 is located substantially in the center of the touch display 802. The haptic output device 808 may either be oriented horizontally or vertically, with respect to the width and length of the touch display 802. For example, it may be advantageous to position the haptic output device 208 anywhere along axis A or axis B, which in this example, bisect the touch display 802 in their respective dimensions. As discussed above with respect to FIG. 2C, these axes run perpendicularly through the source sensor and the axis of rotation, thereby reducing unwanted transfer of haptic effect vibrations to the force sensor 806. As discussed above, with respect to FIG. 2C, it may be advantageous to locate the haptic output device substantially in the center of the touch display to increase the accuracy of pressure readings while reducing noise associated with haptic effects output by haptic output device 808.

While this example uses a FSR, in other examples, the FSR 806 may be replaced by, or used in concert with, a non-contact pressure-sensing device, e.g., a Hall effect sensing device, a proximity sensor, an angular sensor, rotary encoder, torque sensor, displacement sensor, or another non-contact sensing mechanism, to detect an amount of force applied to surface or an amount of rotation about a pivot point. Further, it should be appreciated that the example shown in FIG. 8 may also include any of the additional devices employed herein. In some examples, the touch display 802 may be a deformable surface that is able to output deformation haptic effects. It should be appreciated that the touch display 802 itself may include, or be coupled to, other components than those discussed above, including one or more haptic output devices 808, one or more remote haptic output devices, one or more touch sensors, one or more LEDs, one or more PCBs, one or more display devices, etc.

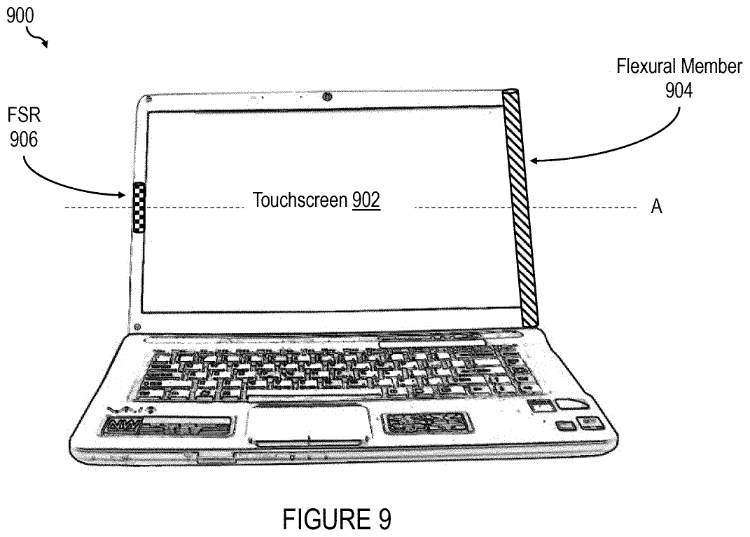

Referring now to FIG. 9, FIG. 9 shows another example force sensor system 900 of the present invention. In this example, force sensor system 900 includes a touchscreen 902 of a laptop computer. Touchscreen 902 rests above force-sensitive resistor (“FSR”) 906, a haptic output device, and a flexural member 904. In this example, the haptic output device (not shown) remains located substantially in the center of the touchscreen 902, along the dotted line representing axis A described above, which may provide a reduction in noisy signals sensed by FSR 906 for the reasons discussed above. The length of the flexural member 904 may vary in accordance with the size of the surface it is attached to. For example, because the relative size of the touchscreen 902 of a laptop may be bigger than the touchscreen of a smartphone, it may be advantageous to increase the length of the flexural member 904 proportionately to the increase in the surface area of the screen. Such an increase in the length of the affixed flexural member 904 may increase the accuracy of pressure readings by reducing flexion associated with an applied contact.

As discussed above, the FSR 906 may be replaced by, or used in concert with, a non-contact pressure-sensing device, e.g., a Hall effect sensing device, a proximity sensor, an angular sensor, rotary encoder, torque sensor, displacement sensor, or another non-contact sensing mechanism, to detect an amount of force applied to surface or an amount of rotation about a pivot point. Further, it should be appreciated that the example shown in FIG. 9 may also include any of the additional devices employed herein. In some examples, the touchscreen 902 may be a deformable surface that is able to output deformation haptic effects. It should be appreciated that the touchscreen 902 itself may include, or be coupled to, other components than those discussed above, including one or more haptic output devices, one or more remote haptic output devices, one or more touch sensors, one or more LEDs, one or more PCBs, one or more display devices, etc.

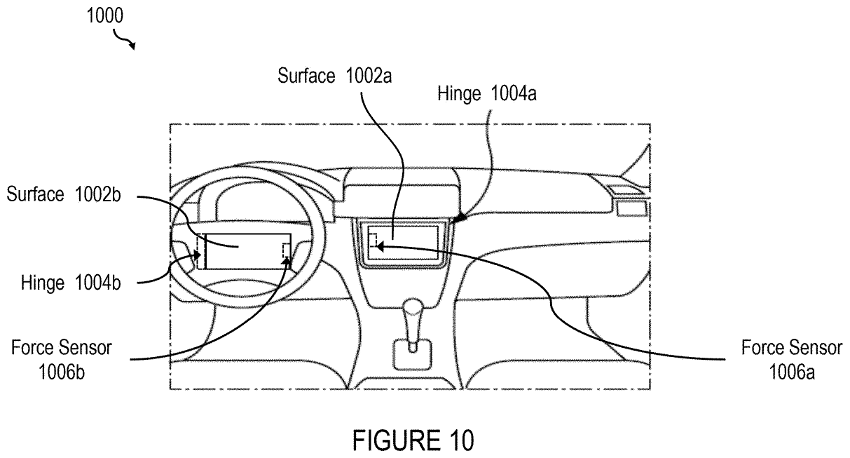

Referring now to FIG. 10, FIG. 10 shows an example of an automobile interior 1000 that includes one or more force sensor systems. This example system includes a force sensor system affixed to an infotainment display screen. The force sensor system includes the surface 1002 of the display screen, a hinge 1004a, which may be a flexural member, coupled to one edge of the display screen and a force sensor 1006a positioned beneath the screen in the middle of the opposite edge of the surface 1002a.

In addition, the vehicle interior also includes surface 1002b, which is located on the vehicle's steering wheel. A hinge 1004b is coupled to one edge of the surface 1002b, and a force sensor 1006b is positioned beneath the middle of the opposite edge of the surface 1002b. Such a configuration may enable touch input to controls displayed on the steering wheel or the infotainment system. In addition, some examples may further include haptic output devices in communication with either or both of the surfaces 1002, 1002b to provide one or more haptically enabled surfaces.

It should be appreciated that the example shown in FIG. 10 may also include any of the additional devices and techniques employed herein. In some examples, the surfaces 1002, 1002b may be a deformable surface that is able to output deformation haptic effects. It should be appreciated that the surfaces 1002, 1002b themselves may include, or be coupled to, other components than those discussed above, including one or more haptic output devices, one or more remote haptic output devices, one or more touch sensors, one or more LEDs, one or more PCBs, one or more display devices, etc. Similarly, hinges 1004a, 1004b and force sensors 1006a, 1006b may be any of the examples described herein.

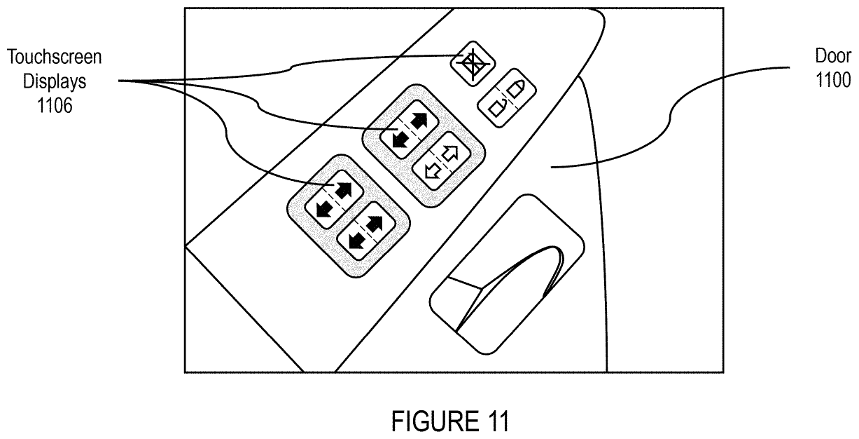

Referring now to FIG. 11, FIG. 11 shows an example of an automobile door 1100 that includes a force sensor system, which can be similar to any of the force sensor systems discussed above. The force sensor system is obscured from view in this example, but would be positioned underneath the touchscreen displays 1106 depicting the vehicle controls (e.g., up and down arrows) on the arm rest of the vehicle's door 1100 in this example. The force sensor system includes sensors that are each associated with a vehicle control depicted on the touchscreen displays 1106. Each touchscreen display 1106 is also coupled to one or more hinges (also obscured from view in this example).

The sensors may sense an amount of force associated with the vehicle controls, such as window up or down controls, car window locks, or power door locks, positioned on the automobile door 1100 and transmit corresponding sensor signals to a computing device that can take action in response to the sensor signals. The force sensor system can alternatively be employed elsewhere in a vehicle to support any suitable vehicle controls, such as in an infotainment system on the dashboard.

In some examples, the force sensor system may employ a double-hinge mechanism, for example as discussed above with respect to FIGS. 5A-B or 6A-B, for bidirectional controls, such as for window up or down buttons. As discussed above, a double-hinge mechanism may enable rocker-style movement of a surface, such as the touch-screen displays 1106 illustrated in FIG. 11. The axis of rotation provided by such double-hinge mechanisms is shown as dashed lines in the Figure. The tilting movement associated with one or more double-hinge mechanisms may cause a computing device (not shown) to transmit a signal to a haptic output device (also not shown) to output a haptic effect based on a haptic signal associated with a user interaction. For example, the computing device may operate a haptic output device (not shown) to produce an effect when a window reaches a maximum height. In some examples, an automobile infotainment system may house the computing device that operates the haptic output device.

It should be appreciated that the example shown in FIG. 11 may also include any of the additional devices and techniques employed herein. In some examples, the touch displays 1106 may be a deformable surface that is able to output deformation haptic effects. And touch displays 1106 may include, or be coupled to, other components than those discussed above, including one or more haptic output devices, one or more remote haptic output devices, one or more touch sensors, one or more LEDs, one or more PCBs, one or more display devices, or other examples described herein.

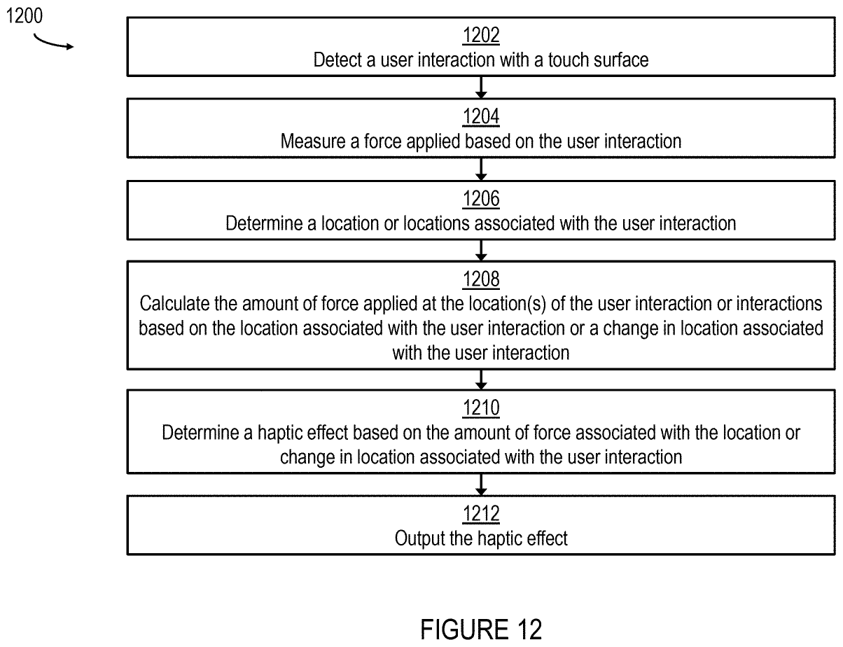

Referring now to FIG. 12, FIG. 12 shows an example method 1200 for providing haptic feedback. In some examples, the blocks shown in FIG. 12 may be implemented in program code that is executable by a processor, for example, the processor in a general purpose computer, a mobile device, or a server. In some embodiments, one or more steps shown in FIG. 12 may be omitted or performed in a different order. Similarly, in some embodiments, additional steps not shown in FIG. 12 may also be performed. For illustrative purposes, the steps of the method 1200 are described below with reference to components described above with regard to the force sensor system 700 shown in FIG. 7, but any suitable system according to this disclosure may be employed.

The method 1200 begins at step 1202 when the computing device 710 or haptic surface 702 detects a user interaction or interactions with the haptic surface 702. In this example, the computing device 710 may receive a signal from the haptic surface 702.

At block 1204, the force sensor 706 senses a response of the surface to the contact. In this example, the force sensor 706 senses a force applied at the location where the haptic surface 702 is in contact with force sensor 706, which is a response of the surface to the user's contact. As a result, the force sensor 706 measures the amount of pressure applied based on the user interaction or interactions and sends the force signal to the computing device 710.

However, it should be appreciated that in some examples, the response of the surface may be sensed based on parameters other than a sensed pressure. For example, in response to an applied force, the surface may deflect towards a proximity sensor, and the sensor may output a sensor signal indicating a change in distance between the sensor and the surface. In some examples, the surface may deflect or rotate about the pivot mechanism, and the sensor may detect an angle of rotation or deflection, or a torque applied to the pivot mechanism. Still, in further examples of sensing, e.g., Hall effect sensing, angular sensing, rotary encoder sensing, torque sensing, displacement sensing, or other non-contact sensing, the response of the surface to an applied force may be employed in conjunction with, or without, measuring the amount of applied force sensed by the force sensor 706.

At block 1206, the computing device 710 determines a location or locations of the user interaction based on the signal received from the haptic surface 702.

At block 1208, the computing device 710 determines the amount of force applied by the user interaction based on the location data associated with the user interaction and the force sensed by the force sensor 706 by computing the expression:

$$\sum {M}_{H i n g e} = - a F + b {F}_{t} = 0 \\ ∴ aF = b {F}_{t} \\ ∴ F = \frac{b}{a} {F}_{t}$$

At block 1210, the computing device 710 determines a haptic effect based on the amount of force F 705 associated with the user interaction or interactions. For example, such location data may include haptic information identifying one or more haptic tracks or a user interaction corresponding to one or more elements displayed on a graphical user interface (“GUI”). A haptic effect may be determined based on the haptic tracks or based on the element of the GUI. In some examples, the computing device 710 may determine a haptic effect based on the total or average calculated amount of force associated with the location or a change in location associated with a user interaction.

At block 1212, the haptic output device 708 outputs the haptic effect. For example, the computing device 710 may transmit a signal to the haptic output device 708 to cause the haptic output device 708 to output the haptic effect. In one example, the haptic output may include one or more haptic tracks associated with the user interaction or interactions. In some examples, the functionality described at block 1212 may be performed in real-time or near real-time. For example, when a haptic track or effect is determined and output without a perceptible lapse in time.

Also, configurations may be described as a process that is depicted as a flow diagram or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

Referring now to FIG. 13, FIG. 13 shows a computing device 1310 for determining an amount of pressure associated with a user interaction of a haptic surface. In addition to the features of the computing device discussed with respect to FIG. 1, the computing device 1310 includes a processor 1312 in communication with other hardware via a bus 1316. The computing device 1310 may be, for example, a personal computer, a mobile device (e.g., a smartphone), a head-mount display, a handheld device (e.g., a tablet), a camera, an automotive device (e.g., an infotainment system), a GPS, a video game device, an electronic control panel (e.g., for an automatic application, a home appliance, an heating or air conditioning system, etc.),or any other type of user device. In some examples, the computing device 1310 can be any type of user interface device that can be used to interact with content (e.g., interact with a simulated reality environment, such as, an augmented or virtual reality environment).

A memory 1314, which can be any suitable tangible (and non-transitory) computer-readable medium such as random access memory (“RAM”), read-only memory (“ROM”), erasable and electronically programmable read-only memory (“EEPROMs”), or the like, embodies program components that configure operation of the computing device 1310. In the embodiment shown, computing device 1310 further includes one or more network interface devices 1330, input/output (I/O) interface components 1340, and storage 1350.

Network interface device 1330 can represent one or more of any components that facilitate a network connection. Examples include, but are not limited to, wired interfaces such as Ethernet, USB, IEEE 1394, and/or wireless interfaces such as IEEE 802.11, Bluetooth, or radio interfaces for accessing cellular telephone networks (e.g., transceiver/antenna for accessing a CDMA, GSM, UMTS, or other mobile communications network).

I/O components 1340 may be used to facilitate wired or wireless connections to devices such as one or more displays, game controllers, keyboards, mice, joysticks, cameras, buttons, speakers, microphones and/or other hardware used to input or output data. Storage 1350 represents nonvolatile storage such as magnetic, optical, or other storage media included in computing device 1310 or coupled to processor 1312.

In some embodiments, the computing device 1310 includes a touch surface 1302 (e.g., a touchpad or touch-sensitive surface) that can be communicatively connected to the bus 1316 and configured to sense tactile input of a user in accordance with any of the techniques described herein. For example, touch surface 1302 may include one or more touch sensors (not shown) that can be configured to detect a touch in a touch area (e.g., when an object contacts the touch surface 1302) and transmits signals associated with the touch to the processor 1312. In some examples, the touch surface 1302 can include any suitable number, type, or arrangement of touch sensors such as, for example, resistive and/or capacitive sensors that can be embedded in touch surface 1302 and used to determine the location of a touch and other information about the touch, such as pressure, speed, and/or direction. In one example, the computing device 1310 can be a smartphone that includes the touch surface 1302 (e.g., a touch-sensitive screen) and a touch sensor of the touch surface 1302 can detect user input when a user of the smartphone touches the touch surface 1302.

In some embodiments, the computing device 1310 comprises a touch-enabled display that combines touch surface 1302 and a display device (not shown) of the computing device 1310. The touch surface 1302 may be overlaid on the display device, may be the display device exterior, or may be one or more layers of material above components of the display device. In other embodiments, the computing device 1310 may display a GUI that includes one or more virtual user interface components (e.g., buttons, knobs, sliders, etc.) on the touch-enabled display and the touch surface 1302 can allow interaction with the virtual user interface components.

In some embodiments, the computing device 1310 further includes a haptic output device 1318 in communication with processor 1312. The haptic output device 1318 is configured to output a haptic track or haptic effect in response to a haptic signal. For example, the haptic output device 1318 can output a haptic track in response to a haptic signal from processor 1312 of the computing device 1310. In some embodiments, the haptic output device 1318 is configured to output a haptic track comprising, for example, a vibration, a squeeze, a poke, a change in perceived coefficient of friction, a simulated texture, a stroking sensation, an electrotactile effect, a surface deformation (e.g., a deformation of a surface associated with the computing device 1310), and/or a puff of a solid, liquid, or gas. Further, some haptic tracks may use multiple haptic output devices 1318 of the same or different types in sequence and/or in concert.

Although a single haptic output device 1318 is shown in FIG. 13, some embodiments may use multiple haptic output devices 1318 of the same or different type to produce different haptic effects. In some embodiments, the haptic output device 1318 may be internal or external to computing device 1310 and in communication with the computing device 1310 (e.g., via wired interfaces such as Ethernet, USB, IEEE 1394, and/or wireless interfaces such as IEEE 802.11, Bluetooth, or radio interfaces). For example, the haptic output device 1318 may be associated with (e.g., coupled to or within) the computing device 1310 and configured to receive haptic signals from the processor 1312.

The haptic output device 1318 may comprise, for example, one or more of a piezoelectric actuator, an electric motor, an electro-magnetic actuator, a voice coil, a shape memory alloy, an electro-active polymer, a solenoid, an eccentric rotating mass motor (“ERM”), a linear resonant actuator (“LRA”), a spinning or scalable rotary actuator (“SRA”), an ultrasonic actuator, a piezo-electric material, a deformation device, an electrostatic actuator, a shape memory material, which includes a metal, polymer, or composite, or a solenoid resonance actuator. In some embodiments, the haptic output device 1318 comprises fluid configured for outputting a deformation haptic effect (e.g., for bending or deforming a surface associated with the computing device 1310). In some embodiments, the haptic output device 1318 comprises a mechanical deformation device. For example, in some embodiments, the haptic output device 1318 may comprise an actuator coupled to an arm that rotates a deformation component. The actuator may comprise a piezo-electric actuator, rotating/linear actuator, solenoid, an electroactive polymer actuator, macro-fiber composite (“MFC”) actuator, shape-memory alloy (“SMA”) actuator, and/or other actuator. As used herein, the term “MFC element” is used to refer to a component or element that acts as both an actuator and a sensor.

In some embodiments, the computing device 1310 can include a user device that can be, for example, a mobile device (e.g., a smartphone), smartwatch, a head-mounted display, a wearable device, a handheld device (e.g., a tablet, video game controller), or any other type of user interface device. In some examples, the user device can be any type of user interface device that can be used to provide content (e.g., texts, images, sounds, videos, a virtual or augmented reality environment, etc.) to a user. In some examples, the user device can be any type of user interface device that can be used to interact with content (e.g., interact with a simulated reality environment, such as, an augmented or virtual reality environment).

In some examples, a specific user interaction may have one or more associated haptic tracks. For example, correspondences between one or more user interactions and one or more haptic tracks may be stored in lookup tables or databases. Each haptic track may include haptic information and be associated with one or more user inputs, such as an amount of pressure, a location of the user input, a pattern of inputs, etc. in the applied force(s) associated with the user interaction(s), and each interaction may be associated with one or more haptic tracks. A haptic track can include a haptic effect (e.g., a vibration, a friction effect, a deformation effect, a thermal effect) or a series of haptic effects that correspond to the user interaction. For example, a user interaction associated with a press and hold event may have one haptic track (e.g., a user input of a thumbprint may have an vibrotactile haptic track), while a user input of a finger press and patterned movement may have a different haptic track (e.g., a friction haptic track).

It should be appreciated that while haptic tracks above have been described as including haptic information about multiple haptic effects, a haptic track may include only a single haptic effect, or may only reference haptic effects that are stored at another location, such as within a haptic library or stored remotely at a server.

In some examples, processor 1312 may execute program code or instructions stored in memory 1314 to monitor the touch surface 1302 for a location of the user interaction. When a user interacts with touch surface 1302, processor 1312 receives location and force signals from touch surface 1302 and sensor 1306, respectively. Processor 1312 then executes program code or instructions to calculate an amount of force applied to the touch surface 1302. In response to determining the location and amount of pressure associated with a user interaction, the processor may executes program code or instructions to determine a haptic effect associated with the signal(s) from the touch surface 1302 and sensor 1004 based on a user interaction that corresponds to a specific haptic effect. After such a determination is made, a signal may be sent to the haptic output device 1318 to generate and output the haptic effect associated with the user interaction. Haptic output device 1318 may output, for example, a vibrotactile effect, an electrostatic effect or any other haptic effect.

It should be appreciated that computing device 1310 may also include additional processors, additional storage, and a computer-readable medium (not shown). The processor(s) 1312 may execute additional computer-executable program instructions stored in memory. Such processors may include a microprocessor, digital signal processor, application-specific integrated circuit, field programmable gate arrays, programmable interrupt controllers, programmable logic devices, programmable read-only memories, electronically programmable read-only memories, or other similar devices.

In order to minimize the amount and complexity of the electronic components involved in the measurement of forces applied to a surface, reducing the number of components is important to decrease the overall size of the haptic components. Making a force sensor configuration thinner, while reducing the number of parts, not only reduces cost and size, but it also ensures greater reliability of the measurements and longevity of the components. Because simplifying the configuration is important, the force sensor may be coupled to the haptic surface using a single flexural member.

The methods, devices, and systems discussed above are examples. Various configurations may omit, substitute, or add various procedures or components. For example, in alternative configurations, the methods may be performed in a different order. In another example, the methods may be performed with fewer steps, more steps, or in combination. In addition, certain configurations may be combined in various configurations. As technology evolves, many of the elements are examples and do not limit the scope of the disclosure or claims.

While some examples of methods, devices, and systems herein are described in terms of software executing on various machines, the methods and systems may also be implemented as specifically-configured hardware, such as field-programmable gate array (FPGA) specifically to execute the various methods according to this disclosure. For example, examples can be implemented in digital electronic circuitry, or in computer hardware, firmware, software, or in a combination thereof. In one example, a device may include a processor or processors. The processor comprises a computer-readable medium, such as a random access memory (RAM) coupled to the processor. The processor executes computer-executable program instructions stored in memory, such as executing one or more computer programs. Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example one or more non-transitory computer-readable media, that may store processor-executable instructions that, when executed by the processor, can cause the processor to perform methods according to this disclosure as carried out, or assisted, by a processor. Examples of non-transitory computer-readable medium may include, but are not limited to, an electronic, optical, magnetic, or other storage device capable of providing a processor, such as the processor in a web server, with processor-executable instructions. Other examples of non-transitory computer-readable media include, but are not limited to, a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may comprise code to carry out methods (or parts of methods) according to this disclosure.

The foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “in one example,” “in an example,” “in one implementation,” or “in an implementation,” or variations of the same in various places in the specification does not necessarily refer to the same example or implementation. Any particular feature, structure, operation, or other characteristic described in this specification in relation to one example or implementation may be combined with other features, structures, operations, or other characteristics described in respect of any other example or implementation.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

That which is claimed is:

1. A system comprising:
a support;
a touch surface configured to detect contact with the touch surface and output one or more contact signals indicating a location of the contact;
a pivot mechanism coupled to the touch surface and the support, the pivot mechanism enabling the touch surface to rotate about a pivot axis;
a sensor positioned to detect a force associated with the contact and to transmit one or more sensor signals indicating the force;
a non-transitory computer-readable medium; and
a processor in communication with the sensor and the non-transitory computer-readable medium, the processor configured to execute processor-executable instructions stored in the non-transitory computer-readable medium to:
receive the one or more sensor signals and the one or more contact signals; and
determine a contact force exerted on the touch surface based on one or more of the contact signals and one or more of the sensor signals.

2. The system of claim 1, further comprising a biasing member, wherein the pivot mechanism or the biasing member is configured to cause the touch surface to apply a pre-compression force on the sensor, the pre-compression force being detectable by the sensor and usable by the processor as a baseline force during a calculation for determining the contact force exerted on the touch surface.

3. The system of claim 1, wherein the pivot mechanism couples a side of the touch surface to the support, and wherein the touch surface is positioned substantially perpendicular to a direction of the force sensing and substantially parallel to the support.

4. The system of claim 3, wherein the side is a first side, and wherein the sensor is positioned proximate the first side of the touch surface or a second side of the touch surface that is opposite to the first side.

5. The system of claim 3, wherein the pivot axis is a first axis, wherein the pivot mechanism is further configured to rotate about a second pivot axis, the first pivot axis being different from the second pivot axis.

6. The system of claim 5, wherein the pivot mechanism further comprising:
a first plank and a second plank;
wherein the first plank couples the touch surface at a first pivot point to enable rotation about the first pivot axis and couples the support at a second pivot point to enable rotation about the second pivot axis; and
wherein the second plank couples to the touch surface at a third pivot point enabling rotation about the first pivot axis and couples to the support at a fourth pivot point to enable rotation about the second pivot axis.

7. The system of claim 6, the system further comprising:
a second sensor positioned proximate the touch surface on a side opposite the sensor, the second sensor configured to detect the force applied to the surface during the contact with the surface and transmit second sensor signals indicating the force; and
the processor further configured to execute processor-executable instructions stored in the non-transitory computer-readable medium to:
receive the second sensor signals from the second sensor; and
determine the contact force exerted on the surface further based in part on the second sensor signals.

8. The system of claim 1, wherein the touch surface is a multi-touch surface, and wherein the processor is further configured to execute processor-executable instructions stored in the non-transitory computer-readable medium to:
determine an average location or a centroid of a region of the multi-touch surface based on the multiple simultaneous contacts during the multi-touch interaction; and
calculate a total force exerted by the contact based on locations of multiple simultaneous contacts with the multi-touch surface during a multi-touch interaction, wherein the total force is calculated based on the average location or the centroid.

9. A method comprising:
receiving, from a touch surface that is coupled to a support by a pivot mechanism and enabled to rotate about a pivot axis by the pivot mechanism, one or more contact signals indicating a location of a contact with the touch surface;
receiving, from a sensor that is positioned to detect a force associated with the contact, one or more sensor signals indicating the force applied to the touch surface during the contact; and
determining a contact force exerted on the touch surface based on one or more of the contact signals and one or more of the sensor signals.

10. The method of claim 9, the method further comprising:
applying, by the pivot mechanism or a biasing member, a pre-compression force on the sensor, the pivot mechanism or the biasing member being configured to cause the touch surface to apply the pre-compression force on the sensor;
receiving, from the sensor, the pre-compression force; and
using, by a processor, the pre-compression force as a baseline force during a calculation for determining the contact force exerted on the touch surface.

11. The method of claim 9, wherein the pivot mechanism couples to a side of the touch surface, and wherein the touch surface is positioned substantially perpendicular to a direction of the force sensing.

12. The method of claim 11, wherein, the side is a first side, and wherein the sensor is a first sensor proximate to the first side of the touch surface, the method further comprising:
receiving, from a second sensor proximate to a second side of the touch surface that is opposite to the first side, one or more sensor signals indicating the force applied to the touch surface.

13. The method of claim 9, wherein the touch surface is a multi-touch surface, the method further comprising:
determining an average location or a centroid of a region of the multi-touch surface based on the multiple simultaneous contacts during the multi-touch interaction; and
calculating a total force exerted by the contact based on locations of multiple simultaneous contacts with the multi-touch surface during a multi-touch interaction, wherein the total force is calculated based on the average location or the centroid.

14. A non-transitory computer readable medium configured to store at least executable instructions, wherein the executable instructions, when executed by a processor, cause the processor to:
receive, from a touch surface that is coupled to a support by a pivot mechanism and enabled to rotate about a pivot axis by the pivot mechanism, one or more contact signals indicating a location of a contact with the touch surface;
receive, from a sensor that is positioned to detect a force associated with the contact, one or more sensor signals indicating the force applied to the touch surface during the contact; and
determine a contact force exerted on the touch surface based on one or more of the contact signals and one or more of the sensor signals.

15. The non-transitory computer readable medium of claim 14, wherein the executable instructions, when executed by the processor, cause the processor to:
apply, by the pivot mechanism or a biasing member, a pre-compression force on the sensor, the pivot mechanism or biasing member being configured to cause the touch surface to apply the pre-compression force on the sensor;
receive, from the sensor, the pre-compression force; and
use, by the processor, the pre-compression force as a baseline force during a calculation for determining the contact force exerted on the touch surface.

16. The non-transitory computer readable medium of claim 19, wherein the touch surface is a multi-touch surface, and wherein the executable instructions, when executed by the processor, cause the processor to:
determine an average location or a centroid of a region of the multi-touch surface based on the multiple simultaneous contacts during the multi-touch interaction; and
calculate a total force exerted by the contact based on locations of multiple simultaneous contacts with the multi-touch surface during a multi-touch interaction, wherein the total force is calculated based on the average location or the centroid.

17. A system comprising:
a support;
a surface;
a pivot mechanism, a first end of the pivot mechanism coupled to the surface and a second end of the pivot mechanism coupled to the support, the pivot mechanism enabling the surface to move with respect to the support;
a first sensor positioned to detect a force associated with a contact with the surface and to transmit first sensor signals indicating the force, the first sensor positioned proximate a first side of the surface;
a second sensor positioned to detect a force associated with a contact with the surface and to transmit second sensor signals indicating the force, the second sensor positioned proximate a second side of the surface, wherein the second side is opposite the first side;
a non-transitory computer-readable medium; and
a processor in communication with the first sensor, the second sensor, and the non-transitory computer-readable medium, the processor configured to execute processor-executable instructions stored in the non-transitory computer-readable medium to:
receive the first sensor signals from the first sensor and the second sensor signals from the second sensor; and
determine a contact force exerted on the surface based on first sensor signals and the second sensor signals.

18. The system of claim 17, further comprising a biasing member, wherein the pivot mechanism or the biasing member is configured to cause the surface to apply a pre-compression force on the first sensor and the second sensor, the pre-compression force being detectable by the first sensor and the second sensor and usable by the processor as a baseline force during a calculation for determining the contact force exerted on the surface.

19. The system of claim 17, wherein the surface lacks touch-sensing capabilities.

20. The system of claim 17, wherein the processor being further configured to execute processor-executable instructions stored in the non-transitory computer-readable medium to:
determine a total amount of force exerted on the surface during the contact based on the first sensor signals and second sensor signals;
determine that a larger portion of the total amount of force is attributable to a first amount of force detected by the first sensor than to a second amount of force detected by the second sensor; and
transmit a haptic signal that causes a haptic output device to output a haptic effect based on the larger portion of the total amount of force being attributable to the first amount of force detected by the first sensor.
